(19) United States
(12) Patent Application Publication
(10) Pub. No.: US 2024/0267273 A1
(43) Pub. Date: Aug. 8, 2024

(54) SIGNAL TRANSMISSION METHOD AND APPARATUS

(71) Applicant: HUAWEI TECHNOLOGIES CO., LTD., Shenzhen (CN)

(72) Inventors: Xu LI, Shenzhen (CN); Jingjing HUANG, Shenzhen (CN); Yibo LV, Dongguan (CN); Junping ZHANG, Shenzhen (CN)

(21) Appl. No.: 18/620,140

(22) Filed: Mar. 28, 2024

Related U.S. Application Data
(63) Continuation of application No. PCT/CN2022/119196, filed on Sep. 16, 2022.

(30) Foreign Application Priority Data
Sep. 30, 2021 (CN) 202111164149.X

(51) Int. Cl. H04L 27/26; H04B 10/516

(52) U.S. Cl. CPC H04L 27/2628; H04B 10/516

(57) ABSTRACT

The method includes: obtaining 2^{N} first signals and 2^{N}−1 second signals, where the first signal and the second signal each include M signal points, a signal value, at an even location, of the signal point of the first signal is 0, a signal value, at an odd location or an even location, of the signal point of the second signal is 0, N is a positive integer, and M is a positive even number; performing inverse fast Fourier transform IFFT, inverse Fourier transform IFT, fast Fourier transform FFT, or Fourier transform FT on the 2^{N} first signals and the 2^{N}−1 second signals to determine 2^{N} third signals and 2^{N}−1 fourth signals.

### CROSS-REFERENCE TO RELATED APPLICATIONS

This application is a continuation of International Application No. PCT/CN2022/119196, filed on Sep. 16, 2022, which claims priority to Chinese Patent Application No. 202111164149.X, filed on Sep. 30, 2021. The disclosures of the aforementioned applications are hereby incorporated by reference in their entireties.

### TECHNICAL FIELD

This application relates to the communication field, and more specifically, to a signal transmission method and apparatus.

### BACKGROUND

In a non-coherent communication system, for example, in intensity-modulation and direct-detection optical communication, an electrical signal is carried on an optical signal, and then the optical signal is transmitted through a wireless channel or a fiber channel. A process in which the electrical signal is carried on the optical signal may usually be implemented by adjusting intensity of the optical signal by using the electrical signal. The intensity of the optical signal is briefly referred to as light intensity. The light intensity is equivalent to a quantity of photons, to be specific, when the light intensity is strong, the optical signal includes more photons; and when the light intensity is weak, the optical signal includes fewer photons. Because the quantity of photons can only be a number greater than or equal to 0, the light intensity can only be a positive value. Therefore, the carried electrical signal needs to be a non-negative real number.

The electrical signal may be an OFDM (Orthogonal Frequency Division Multiplexing, orthogonal frequency division multiplexing) signal. As described above, in the optical communication, a time domain signal of the electrical OFDM signal is required to be the non-negative real number.

In the existing solution in which the electrical signal is carried on the optical signal for signal transmission, it is ensured that a baseband signal of the OFDM signal is the non-negative real number at the expense of spectral efficiency and/or power consumption. Therefore, how to improve the spectral efficiency without increasing the power consumption while ensuring that the baseband signal of the OFDM signal is the non-negative real number becomes an urgent problem to be resolved.

### SUMMARY

This application provides a signal transmission method and apparatus. A transmitter performs mixing on obtained 2^{N} first signals and 2^{N}−1 second signals according to a rule, so that a receiver can restore the 2^{N} first signals and the 2^{N}−1 second signals based on a received fifth signal. Moreover, according to the method, the transmitter outputs a non-negative signal and obtains high spectral efficiency without adding a direct current bias.

It should be understood that the signal transmission method may be performed by the transmitter or the receiver, or may be performed by a chip or a circuit disposed in the transmitter or the receiver. This is not limited in this application. In addition, in this application, a signal sending device may be referred to as a transmitter, a transmitting device, a first device, or the like, and a signal receiving device may be referred to as a receiver, a receiving device, a second device, or the like. This is not limited in this application. For ease of description, the signal sending device is the transmitter, and the signal receiving device is the receiver below.

According to a first aspect, a signal transmission method is provided. The signal transmission method includes:

A transmitter obtains 2^{N} first signals and 2^{N}−1 second signals, where the first signal includes M signal points, a signal value, at an even location, of the M signal points of the first signal is 0, the second signal includes M signal points, a signal value, at an odd location or an even location, of the M signal points of the second signal is 0, N is a positive integer, and M is a positive even number; the transmitter performs inverse fast Fourier transform IFFT, inverse Fourier transform IFT, fast Fourier transform FFT, or Fourier transform FT on the 2^{N} first signals and the 2^{N}−1 second signals to determine 2^{N} third signals and 2^{N}−1 fourth signals, where the third signal includes M signal points, and the fourth signal includes M signal points; the transmitter determines a fifth signal based on the 2^{N} third signals and the 2^{N}−1 fourth signals, where the fifth signal includes M*2^{N} signal points; and the transmitter sends the fifth signal.

According to the signal transmission method provided in this application, the transmitter performs separation processing on signal points of a total of M*(2^{N+1}−1) first and second signals, then performs mixing to obtain the fifth signal including the M*2^{N} signal points, and sends the fifth signal to a receiver. The receiver restores the 2^{N} first signals and the 2^{N}−1 second signals based on the fifth signal, to improve spectral efficiency of signal transmission while ensuring that a baseband signal of a to-be-sent signal (for example, an OFDM signal) is a non-negative real number and no power consumption is increased.

With reference to the first aspect, in an embodiment of the first aspect, as described in the method, that the transmitter determines a fifth signal based on the 2^{N} third signals and the 2^{N}−1 fourth signals includes:

The transmitter determines 2^{N} sixth signals and 2^{N} seventh signals based on the 2^{N} third signals, where the sixth signal includes M/2 signal points, the seventh signal includes M/2 signal points, each third signal one-to-one corresponds to one sixth signal and one seventh signal, an i^{th} sixth signal in the 2^{N} sixth signals and an i^{th} seventh signal in the 2^{N} seventh signals are determined based on an i^{th} third signal in the 2^{N} third signals, and i is a positive integer less than or equal to 2^{N}; the transmitter determines 2^{N}−1 eighth signals and 2^{N}−1 ninth signals based on the 2^{N}−1 fourth signals, where the eighth signal includes M/2 signal points, the ninth signal includes M/2 signal points, each fourth signal one-to-one corresponds to one eighth signal and one ninth signal, for example, an x^{th} eighth signal in the 2^{N}−1 eighth signals and an x^{th} ninth signal in the 2^{N}−1 ninth signals are determined based on an x^{th} fourth signal in the 2^{N}−1 fourth signals, and x is a positive integer less than or equal to 2^{N}−1; and the transmitter determines the fifth signal by performing signal mixing based on the 2^{N} sixth signals, the 2^{N} seventh signals, the 2^{N}−1 eighth signals, and the 2^{N}−1 ninth signals.

The third signal and the fourth signal meet symmetry or antisymmetry. Therefore, the third signal may be separated based on the symmetry or the antisymmetry to obtain the sixth signal and the seventh signal, and the fourth signal may be separated to obtain the eighth signal and the ninth signal.

In an embodiment, that an i^{th} sixth signal in the 2^{N} sixth signals and an i^{t}h seventh signal in the 2^{N} seventh signals are determined based on an i^{th} third signal in the 2^{N} third signals includes:

The i^{th} sixth signal is obtained by setting a signal value that is less than 0 and that corresponds to the first M/2 signal points of the i^{th} third signal, or the i^{th} sixth signal is obtained by setting a signal value that is greater than 0 and that corresponds to the last M/2 signal points of the i^{th} third signal to 0 and calculating an absolute value of a signal value that is less than 0 and that corresponds to the last M/2 signal points of the i^{th} third signal; and the i^{t}h seventh signal is obtained by setting the signal value that is less than 0 and that corresponds to the last M/2 signal points of the i^{th} third signal, or the i^{th} seventh signal is obtained by setting a signal value that is greater than 0 and that corresponds to the first M/2 signal points of the i^{th} third signal to 0 and calculating an absolute value of the signal value that is less than 0 and that corresponds to the first M/2 signal points of the i^{th} third signal.

In an embodiment, that an x^{th} eighth signal in the 2^{N}−1 eighth signals and an x^{th} ninth signal in the 2^{N}−1 ninth signals are determined based on an x^{th} fourth signal in the 2^{N}−1 fourth signals includes:

If the second signal corresponding to the fourth signal is a second signal with a value of 0 at an odd location, the x^{th} eighth signal is obtained by setting a signal value that is less than 0 and that corresponds to the first M/2 signal points or the last M/2 signal points of the x^{th} fourth signal; and the x^{th} ninth signal is obtained by setting a signal value that is greater than 0 and that corresponds to the first M/2 signal points or the last M/2 signal points of the x^{th} fourth signal to 0 and calculating an absolute value of the signal value that is less than 0 and that corresponds to the first M/2 signal points or the last M/2 signal points of the x^{th} fourth signal.

If the second signal corresponding to the fourth signal is a second signal with a value of 0 at an even location, the x^{th} eighth signal is obtained by setting a signal value that is less than 0 and that corresponds to the first M/2 signal points of the x^{th} fourth signal, or the x^{th} eighth signal is obtained by setting a signal value that is greater than 0 and that corresponds to the last M/2 signal points of the x^{th} fourth signal to 0 and calculating an absolute value of a signal value that is less than 0 and that corresponds to the last M/2 signal points of the x^{th} fourth signal; and the x^{th} ninth signal is obtained by setting the signal value that is less than 0 and that corresponds to the last M/2 signal points of the x^{th} fourth signal, or the x^{th} ninth signal is obtained by setting a signal value that is greater than 0 and that corresponds to the first M/2 signal points of the x^{th} fourth signal to 0 and calculating an absolute value of the signal value that is less than 0 and that corresponds to the first M/2 signal points of the x^{th} fourth signal.

It should be noted that, when the transmitter performs the signal mixing on the signal to obtain the fifth signal, a principle needs to be followed, so that the receiver can restore the 2^{N} first signals and the 2^{N}−1 second signals based on the received fifth signal.

In an embodiment, the M*2^{N} signal points of the fifth signal include 2^{N} groups of signal points, each group of signal points includes M signal points, the 2^{N} groups of signal points one-to-one correspond to the 2^{N} first signals and 2^{N} signal combinations, M/2 signal points in one group of signal points that is of the fifth signal and that corresponds to an i^{th} first signal are determined based on the i^{th} sixth signal and an i^{th} signal combination, the other M/2 signal points are determined based on the i^{th} seventh signal and the i^{th} signal combination, the signal combination includes at least N eighth signals and/or ninth signals, the at least N eighth signals and/or ninth signals are determined based on at least N different fourth signals, and any two signal combinations in the 2^{N} signal combinations include at least one different eighth signal or ninth signal.

That M/2 signal points in one group of signal points that is of the fifth signal and that corresponds to an i^{th} first signal are determined based on the i^{th} sixth signal and an i^{th} signal combination includes:

A signal value of the M/2 signal points in the group of signal points that is of the fifth signal and that corresponds to the i^{th} first signal is a sum of a signal value of M/2 signal points of the i^{th} sixth signal and a signal value, at a corresponding location, of N*M/2 signal points of the at least N eighth signals and/or ninth signals included in the i^{th} signal combination.

That the other M/2 signal points are determined based on the i^{th} seventh signal and the i^{th} signal combination includes:

A signal value of the other M/2 signal points in the group of signal points that is of the fifth signal and that corresponds to the i^{th} first signal is a sum of a signal value of M/2 signal points of the i^{th} seventh signal and the signal value, at the corresponding location, of the N*M/2 signal points of the at least N eighth signals and/or ninth signals included in the i^{th} signal combination.

It should be noted that in this application, M/2 signal points and the other M/2 signal points that correspond to each group of signal points may not be sent at adjacent time, and a transmission sequence of each group of signal points is not limited in this application, thereby improving flexibility of the solution.

According to a second aspect, a signal transmission method is provided. The signal transmission method includes:

A transmitter obtains a fifth signal, where the fifth signal includes M*2^{N} signal points, N is a positive integer greater than or equal to 1, and M is a positive even number; and the transmitter performs at least one of the following operations on the fifth signal to determine 2^{N} first signals and 2^{N}−1 second signals, where the first signal includes M signal points, a signal value, at an even location, of the M signal points of the first signal is 0, the second signal includes M signal points, a signal value, at an odd location or an even location, of the M signal points of the second signal is 0, and the operation includes: inverse fast Fourier transform IFFT, inverse Fourier transform IFT, fast Fourier transform FFT, or Fourier transform FT.

According to the signal transmission method provided in this application, a receiver receives the fifth signal, and the receiver performs separation on the fifth signal based on the fifth signal, to restore the 2^{N} first signals and the 2^{N}−1 second signals, so as to improve spectral efficiency of signal transmission while ensuring that a baseband signal of a to-be-sent signal (for example, an OFDM signal) is a non-negative real number and no power consumption is increased.

The transmitter may perform the separation on the fifth signal based on a combination manner of the fifth signal, to restore the 2^{N} first signals and the 2^{N}−1 second signals. In an embodiment, the M*2^{N} signal points of the fifth signal include 2^{N} groups of signal points, each group of signal points includes M signal points, and the 2^{N} groups of signal points one-to-one correspond to the 2^{N} first signals and 2^{N} signal combinations. Each signal combination includes at least N eighth signals and/or ninth signals corresponding to different fourth signals, and any two signal combinations include at least one different eighth signal or ninth signal.

With reference to the second aspect, in an embodiment of the second aspect, as described in the method, that the transmitter performs at least one of the following operations on the fifth signal to obtain 2^{N} first signals and 2^{N}−1 second signals includes:

The receiver separately performs IFFT, IFT, FFT, or FT on the 2^{N} groups of signal points of the fifth signal to obtain the 2^{N} first signals; the receiver separately performs IFFT, IFT, FFT, or FT on the 2^{N} first signals to determine 2^{N} third signals, where the third signal includes M signal points; the receiver determines the 2^{N} signal combinations based on the 2^{N} third signals; and the receiver determines the 2^{N}−1 second signals based on the 2^{N} signal combinations, where the operation includes IFFT, IFT, FFT, or FT.

In an embodiment, that the receiver determines the 2^{N} signal combinations based on the 2^{N} third signals includes:

The receiver determines 2^{N} sixth signals and/or 2^{N} seventh signals based on the 2^{N} third signals, where the sixth signal includes M/2 signal points, the seventh signal includes M/2 signal points, an i^{th} sixth signal in the 2^{N} sixth signals and an i^{th} seventh signal in the 2^{N} seventh signals are determined based on an i^{th} third signal in the 2^{N} third signals, and i is a positive integer less than or equal to 2^{N}; and the receiver determines the 2^{N} signal combinations based on the 2^{N} sixth signals and/or 2^{N} seventh signals.

In an embodiment, that the receiver obtains the 2^{N}−1 second signals based on the 2^{N} signal combinations includes:

The receiver determines 2^{N}−1 fourth signals based on the 2^{N} signal combinations, where the fourth signal includes M signal points; and the receiver separately performs IFFT, IFT, FFT, or FT on the 2^{N}−1 fourth signals to obtain the 2^{N}−1 second signals.

In an embodiment, that the receiver determines the 2^{N} signal combinations based on the 2^{N} sixth signals and/or 2^{N} seventh signals includes:

The receiver determines the 2^{N} signal sets based on M/2 signal points of each group of signal points in the 2^{N} groups of signal points of the fifth signal and a sixth signal determined based on a first signal corresponding to each group of signal points, or the receiver determines the 2^{N} signal sets based on the other M/2 signal points of the group of signal points of the 2^{N} groups of signal points of the fifth signal and a seventh signal determined based on a first signal corresponding to the group of signal points, where an i^{th} signal combination is determined based on M/2 signal points of one group of signal points corresponding to an i^{th} first signal and the i^{th} sixth signal determined based on the i^{th} first signal, or an i^{th} signal combination is determined based on the other M/2 signal points of one group of signal points corresponding to an i^{th} first signal and the i^{th} seventh signal determined based on the i^{th} first signal.

In an embodiment, that the receiver determines 2^{N}−1 fourth signals based on the 2^{N} signal combinations includes:

The receiver determines a maximum of 2^{N}−1 eighth signals, a maximum of 2^{N}−1 ninth signals, and a relationship between the maximum of 2^{N}−1 eighth signals and the maximum of 2^{N}−1 ninth signals based on the 2^{N} signal combinations, where the eighth signal includes M/2 signal points, and the ninth signal includes M/2 signal points; and the receiver determines the 2^{N}−1 fourth signals based on the maximum of 2^{N}−1 eighth signals, the maximum of 2^{N}−1 ninth signals, and the relationship between the maximum of 2^{N}−1 eighth signals and the maximum of 2^{N}−1 ninth signals, where
the 2^{N}−1 eighth signals and the 2^{N}−1 ninth signals are determined based on the 2^{N}−1 fourth signals, an x^{th} eighth signal in the 2^{N}−1 eighth signals and an x^{th} ninth signal in the 2^{N}−1 ninth signals are determined based on an x^{th} fourth signal in the 2^{N}−1 fourth signals, and x is a positive integer less than or equal to 2^{N}−1.

It should be noted that the sixth signal, the seventh signal, the eighth signal, and the ninth signal are obtained by separating the third signal and the fourth signal. An obtaining manner is as follows:

That an i^{th} sixth signal in the 2^{N} sixth signals and an i^{th} seventh signal in the 2^{N} seventh signals are determined based on an i^{th} third signal in the 2^{N} third signals includes:

The i^{th} sixth signal is obtained by setting a signal value that is less than 0 and that corresponds to the first M/2 signal points of the i^{th} third signal, or the i^{th} sixth signal is obtained by setting a signal value that is greater than 0 and that corresponds to the last M/2 signal points of the i^{th} third signal to 0 and calculating an absolute value of a signal value that is less than 0 and that corresponds to the last M/2 signal points of the i^{th} third signal; and the i^{th} seventh signal is obtained by setting the signal value that is less than 0 and that corresponds to the last M/2 signal points of the i^{th} third signal, or the i^{th} seventh signal is obtained by setting a signal value that is greater than 0 and that corresponds to the first M/2 signal points of the i^{th} third signal to 0 and calculating an absolute value of the signal value that is less than 0 and that corresponds to the first M/2 signal points of the i^{th} third signal.

That an x^{th} eighth signal in the 2^{N}−1 eighth signals and an x^{th} ninth signal in the 2^{N}−1 ninth signals are determined based on an x^{th} fourth signal in the 2^{N}−1 fourth signals, and x is a positive integer less than or equal to 2^{N}−1 includes:

When the second signal corresponding to the fourth signal is a second signal with a value of 0 at an odd location, the x^{th} eighth signal is obtained by setting a signal value that is less than 0 and that corresponds to the first M/2 signal points or the last M/2 signal points of the x^{th} fourth signal to 0; and the x^{th} ninth signal is obtained by setting a signal value that is greater than 0 and that corresponds to the first M/2 signal points or the last M/2 signal points of the x^{th} fourth signal to 0 and calculating an absolute value of the signal value that is less than 0 and that corresponds to the first M/2 signal points or the last M/2 signal points of the x^{th} fourth signal.

When the second signal corresponding to the fourth signal is a second signal with a value of 0 at an even location, the x^{th} eighth signal is obtained by setting a signal value that is less than 0 and that corresponds to the first M/2 signal points of the x^{th} fourth signal, or the x^{th} eighth signal is obtained by setting a signal value that is greater than 0 and that corresponds to the last M/2 signal points of the x^{th} fourth signal to 0 and calculating an absolute value of a signal value that is less than 0 and that corresponds to the last M/2 signal points of the x^{th} fourth signal; and the x^{th} ninth signal is obtained by setting the signal value that is less than 0 and that corresponds to the last M/2 signal points of the x^{th} fourth signal, or the x^{th} ninth signal is obtained by setting a signal value that is greater than 0 and that corresponds to the first M/2 signal points of the x^{th} fourth signal to 0 and calculating an absolute value of the signal value that is less than 0 and that corresponds to the first M/2 signal points of the x^{th} fourth signal.

According to a third aspect, a signal transmission apparatus is provided. The signal transmission apparatus includes a processor, configured to implement a function of the transmitter in the method according to the first aspect.

In an embodiment, the signal transmission apparatus may further include a memory. The memory is coupled to the processor, and the processor is configured to implement the function of the transmitter in the method according to the first aspect.

In an embodiment, the memory is configured to store program instructions and data. The memory is coupled to the processor. The processor may invoke and execute the program instructions stored in the memory, to implement the function of the transmitter in the method according to the first aspect.

In an embodiment, the signal transmission apparatus may further include a communication interface. The communication interface is used by the signal transmission apparatus to communicate with another device. When the signal transmission apparatus is a transmitter, the transceiver may be a communication interface or an input/output interface.

In an embodiment, the signal transmission apparatus includes a processor and a communication interface, configured to implement the function of the transmitter in the method according to the first aspect, and includes: The processor communicates with the outside through the communication interface. The processor is configured to run a computer program, to enable the apparatus to implement any method according to the first aspect.

It may be understood that the outside may be an object other than the processor or an object other than the apparatus.

In an embodiment, when the signal transmission apparatus is a chip or a chip system, the communication interface may be an input/output interface, an interface circuit, an output circuit, an input circuit, a pin, a related circuit, or the like in the chip or the chip system. The processor may alternatively be a processing circuit or a logic circuit.

According to a fourth aspect, a signal transmission apparatus is provided. The signal transmission apparatus includes a processor, configured to implement a function of the receiver in the method according to the second aspect.

In an embodiment, the signal transmission apparatus may further include a memory. The memory is coupled to the processor, and the processor is configured to implement the function of the receiver in the method according to the second aspect.

In an embodiment, the memory is configured to store program instructions and data. The memory is coupled to the processor. The processor may invoke and execute the program instructions stored in the memory, to implement the function of the receiver in the method according to the second aspect.

In an embodiment, the signal transmission apparatus may further include a communication interface. The communication interface is used by the signal transmission apparatus to communicate with another device. When the signal transmission apparatus is a receiver, the transceiver may be a communication interface or an input/output interface.

In an embodiment, the signal transmission apparatus includes a processor and a communication interface, configured to implement the function of the receiver in the method according to the second aspect, and includes: The processor communicates with the outside through the communication interface. The processor is configured to run a computer program, to enable the apparatus to implement any method according to the second aspect.

It may be understood that the outside may be an object other than the processor or an object other than the apparatus.

In an embodiment, when the signal transmission apparatus is a chip or a chip system, the communication interface may be an input/output interface, an interface circuit, an output circuit, an input circuit, a pin, a related circuit, or the like in the chip or the chip system. The processor may alternatively be a processing circuit or a logic circuit.

According to a fifth aspect, a communication apparatus is provided, including:
an input interface (circuit), configured to obtain 2^{N} first signals and 2^{N}−1 second signals;
a logic circuit, configured to obtain a fifth signal according to the first aspect and the implementations of the first aspect; and an output interface (circuit), configured to output the fifth signal.

According to a sixth aspect, a communication apparatus is provided, including:
an input interface (circuit), configured to obtain a fifth signal;
a logic circuit, configured to obtain 2^{N} first signals and 2^{N}−1 second signals according to the second aspect and the implementations of the second aspect; and
an output interface (circuit), configured to output the 2^{N} first signals and the 2^{N}_1 second signals.

According to a seventh aspect, a computer-readable storage medium is provided, and stores a computer program or instructions. When the computer program or the instructions is/are run on a computer, the method according to any one of the first aspect and the possible implementations of the first aspect is performed.

According to an eighth aspect, a computer-readable storage medium is provided, and stores a computer program or instructions. When the computer program or the instructions is/are run on a computer, the method according to any one of the second aspect and the possible implementations of the second aspect is performed.

According to a ninth aspect, a computer program product including instructions is provided. When the instructions are run on a computer, the method according to any one of the first aspect and the possible implementations of the first aspect is performed.

According to a tenth aspect, a computer program product including instructions is provided. When the instructions are run on a computer, the method according to any one of the second aspect and the possible implementations of the second aspect is performed.

According to an eleventh aspect, a signal transmission device is provided, including the signal transmission apparatus according to the third aspect and the signal transmission apparatus according to the fourth aspect.

### BRIEF DESCRIPTION OF DRAWINGS

FIG. 1 is a schematic diagram of a system architecture according to an embodiment of this application;

FIG. 2 is a schematic diagram of a time domain signal of an OFDM signal that meets an HS constraint according to an embodiment of this application;

FIG. 3 is a schematic diagram of a time domain signal of an OFDM signal based on a DCO-OFDM method;

FIG. 4 is a schematic diagram of a time domain signal of an OFDM signal that meets an HS constraint and whose even location is set to 0;

FIG. 5 is a schematic diagram of a time domain signal of an OFDM signal based on an ACO-OFDM method;

FIG. 6 is a schematic diagram of a time domain signal of an OFDM signal based on a U-OFDM method;

FIG. 7 is a schematic flowchart of a signal transmission method according to an embodiment of this application;

FIG. 8 shows an example of a third signal according to an embodiment of this application;

FIG. 9 shows another example of a third signal according to an embodiment of this application;

FIG. 10 shows an example of a fourth signal according to an embodiment of this application;

FIG. 11 shows an example of an air interface signal corresponding to a fifth signal according to an embodiment of this application;

FIG. 12 shows another example of an air interface signal corresponding to a fifth signal according to an embodiment of this application;

FIG. 13 shows an example of a signal transmission apparatus according to an embodiment of this application;

FIG. 14 shows another example of a signal transmission apparatus according to an embodiment of this application; and

FIG. 15 shows another example of a signal transmission apparatus according to an embodiment of this application.

### DESCRIPTION OF EMBODIMENTS

The following describes technical solutions of this application with reference to accompanying drawings.

Terms used in the following embodiments are merely for the purpose of describing embodiments, but are not intended to limit this application. Terms “one”, “a”, “the”, “the foregoing”, “this”, and “the one” of singular forms used in this specification and the appended claims of this application are intended to also include expressions such as “one or more”, unless otherwise specified in the context clearly. It should be further understood that in the following embodiments of this application, “at least one” and “one or more” mean one, two, or more.

Reference to “an embodiment”, “some embodiments”, or the like described in this specification indicates that one or more embodiments of this application include a feature, structure, or characteristic described with reference to embodiments. Therefore, statements such as “in an embodiment”, “in some embodiments”, “in some other embodiments”, and “in other embodiments” that appear at different places in this specification do not necessarily mean reference to a same embodiment, instead, they mean “one or more but not all of the embodiments”, unless otherwise emphasized n another manner. Terms “include”, “have”, and their variants all mean “include but are not limited to”, unless otherwise emphasized in another manner.

To better understand embodiments of this application, the following describes a signal transmission system applicable to embodiments of this application by using a signal transmission system shown in FIG. 1 as an example. FIG. 1 is a schematic diagram of a signal transmission system 100 applicable to a signal transmission method according to an embodiment of this application.

As shown in FIG. 1, the signal transmission system 100 may include at least one transmitter, for example, a transmitter 110 shown in FIG. 1. The signal transmission system 100 may further include at least one receiver, for example, a receiver 120 shown in FIG. 1. The transmitter 110 may communicate with the receiver 120 by using a wireless link or a wired link (for example, an optical fiber or an optical cable).

A plurality of wireless links may be configured for each device, for example, the transmitter 110 or the receiver 120. For the transmitter 110 in the signal transmission system 100, the plurality of configured wireless links may include at least one transmit wireless link used to send an optical signal. For the receiver 120 in the optical signal transmission system 100, the plurality of configured wireless links may include at least one receive wireless link used to receive an optical signal.

The transmitter and the receiver in this application may be various terminal devices, for example, user equipment (UE), an access terminal, a subscriber unit (English: subscriber unit), a subscriber station, a mobile console, a mobile station, a remote station, a remote terminal, a mobile device, terminal equipment (TE), a terminal, a wireless communication device, a user agent or a user apparatus, a tablet computer (Pad), a handheld device with a wireless communication function, a computing device or another processing device connected to a wireless modem, a vehicle-mounted device, a vehicle-mounted communication module, a wearable device, a terminal device in a 5th generation communication 5G network or a network after 5G, a terminal and a car in intelligent transportation, a home device in smart home, an electric meter reading instrument in a smart grid, a voltage monitoring instrument, an environmental monitoring instrument, a video surveillance instrument in an intelligent security network, a cash register, a machine type communication (MTC) terminal, a laser communication transceiver, an LED optical communication transceiver, a wired optical fiber communication transceiver, a wired optical fiber communication transceiver, an optical module, or the like. This is not limited in this application.

Alternatively, the transmitter and the receiver in this application may be various network devices or access devices in a communication system, that is, devices configured to communicate with a terminal device. For example, the transmitter and the receiver may be an evolved NodeB (Evolved NodeB, eNB or eNodeB) in a long term evolution (LTE) system, a next generation NodeB (English: next generation NodeB, gNB) in a 5G system, a transmission reception point (TRP), a relay node, an access point (AP), a macro base station (Macro Base Station), a micro base station (Micro Base Station), an indoor AP node, or the like. This is not limited in this application.

It should be understood that FIG. 1 is merely a simplified schematic diagram used as an example for ease of understanding. The signal transmission system 100 may further include another transmitter or another receiver that is not shown in FIG. 1.

To facilitate understanding of embodiments of this application, the following describes some basic concepts in embodiments of this application.

### 1. Hermitian Symmetry Constraint

A process of generating an OFDM signal carried on an optical signal for transmission mainly includes:

First, M frequency domain signals are generated, and then M time domain signals are obtained through inverse fast Fourier transform (inverse fast Fourier transform, IFFT), where M is a positive integer.

In optical communication, the M time domain signals of the OFDM signal need to be non-negative real numbers. In an embodiment, the non-negative real number may be divided into two parts: (1) real number; and (2) non-negative number.

To meet a requirement that the time domain signal is a real number, the M frequency domain signals of the OFDM signal need to meet a Hermitian symmetry (HS) constraint:

$${X}_{m} = {X}_{M - m}^{*}$$

$$0 < m < \frac{M}{2}$$

$${X}_{0} = {X}_{\frac{M}{2}}$$

where Xₘ is a frequency domain signal whose index value is m in the M frequency domain signals, X*_{M-m} is a conjugate value of a frequency domain signal whose index value is M−m in the M frequency domain signals, and X_{M/2} is a frequency domain signal whose index value is M/2 in the M frequency domain signals.

The HS constraint is widely applied to the field of optical communication, to ensure that a time domain signal of an OFDM signal is a real number. However, the HS constraint cannot ensure that the M time domain signals of the OFDM signal are non-negative numbers.

To further meet a requirement that the M time domain signals of the OFDM signal are non-negative numbers, there are different methods in the field of optical communication, for example, a direct-current-biased optical orthogonal frequency division multiplexing (DCO-OFDM) method, an asymmetrically-clipped optical orthogonal frequency division multiplexing (ACO-OFDM) method, and a unipolar orthogonal frequency division multiplexing (U-OFDM) method.

The following briefly describes the methods for ensuring that the M time domain signals of the OFDM signal are non-negative numbers.

### 2. Direct-Current-Biased Optical Orthogonal Frequency Division Multiplexing Method

In the DCO-OFDM method, a direct current bias is added to the time domain signal of the OFDM signal, to ensure that the time domain signal of the OFDM signal is a non-negative number.

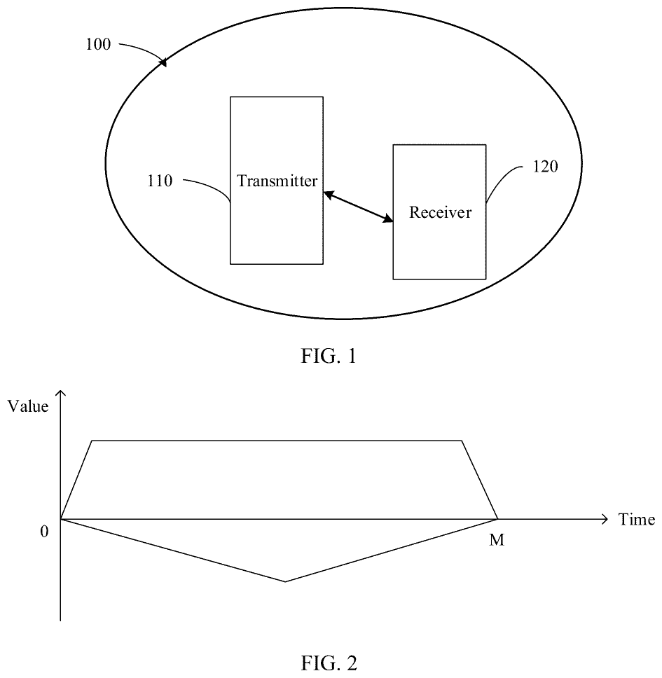

In an embodiment, as shown in FIG. 2, when the M frequency domain signals (for example, X(0), X(1), . . . , X(M−1)) of the OFDM signal meet the HS constraint, the M time domain signals (for example, x(0), x(1), . . . , x(M−1)) of the OFDM signal are real numbers. FIG. 2 is a schematic diagram of a time domain signal of an OFDM signal that meets the HS constraint.

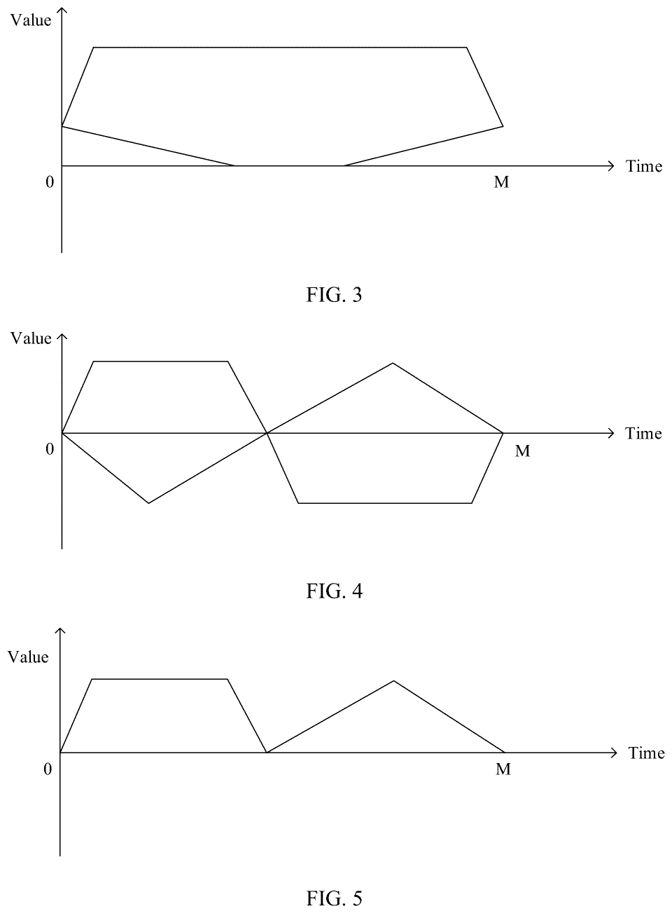

Details are shown in FIG. 3. FIG. 3 is a schematic diagram of a time domain signal of an OFDM signal based on a DCO-OFDM method.

Because the HS constraint is met, when the OFDM signal is transmitted by using the DCO-OFDM method, spectral efficiency is ½, and a direct current bias is required. As a result, power consumption of signal transmission is increased.

### 3. Asymmetrically-Clipped Optical Orthogonal Frequency Division Multiplexing Method

In the ACO-OFDM method, a frequency domain signal, at an even location, of the OFDM signal is set to 0, so that the time domain signal of the OFDM signal meets symmetry. Further, based on symmetry, a negative time domain signal is directly set to 0.

In an embodiment, as shown in FIG. 2, when the N frequency domain signals (for example, X(0), X(1), . . . , X(M−1)) of the OFDM signal meet the HS constraint, the N time domain signals (for example, x(0), x(1), . . . , x(M−1)) of the OFDM signal are real numbers.

Details are shown in FIG. 4. FIG. 4 is a schematic diagram of a time domain signal of an OFDM signal that meets the HS constraint and whose even location is set to 0.

Details are shown in FIG. 5. FIG. 5 is a schematic diagram of a time domain signal of an OFDM signal based on an ACO-OFDM method.

Due to symmetry, original signal information is not lost. In comparison with the DCO-OFDM method, because a frequency domain signal, at an even location, of an OFDM signal is set to 0, spectral efficiency is ¼. However, because no direct current bias is required, power consumption is reduced at the expense of half of spectral efficiency.

### 4. Unipolar Orthogonal Frequency Division Multiplexing Method

In the U-OFDM method, a negative part of a time domain signal of an OFDM signal is reversed and then placed at the end of the time domain signal of the OFDM signal for transmission.

In an embodiment, as shown in FIG. 2, when the M frequency domain signals (for example, X(0), X(1), . . . , X(M−1)) of the OFDM signal meet the HS constraint, the M time domain signals (for example, x(0), x(1), . . . , x(M−1)) of the OFDM signal are real numbers.

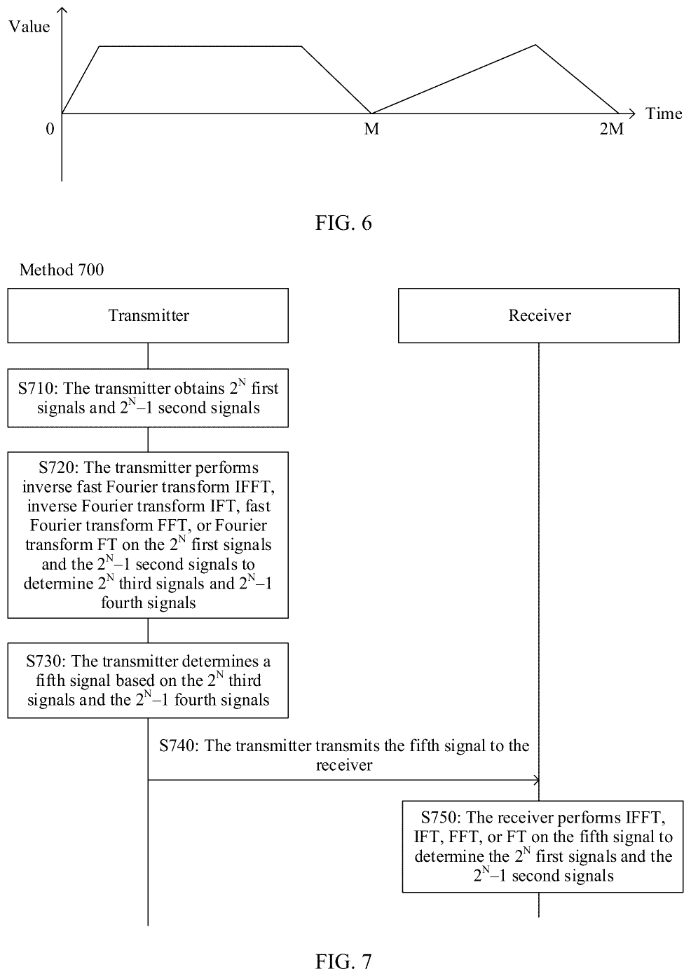

Details are shown in FIG. 6. FIG. 6 is a schematic diagram of a time domain signal of an OFDM signal based on a U-OFDM method.

Compared with the DCO-OFDM method, the U-OFDM method doubles time with spectral efficiency of ¼. In other words, half of time efficiency is decreased, which is equivalent to decreasing half of spectral efficiency. However, because no direct current bias is required, power consumption is reduced.

As described above, a signal transmitted in the visible light field needs to be a non-negative real number. To meet the requirement, in the DCO-OFDM method, the signal transmission is implemented by using the direct current bias, and the spectral efficiency is ½. However, because the direct current bias is required, the power consumption is increased. In the ACO-OFDM method and the U-OFDM method, although the direct current bias is not required and the power consumption is reduced, the spectral efficiency is ¼. In other words, the several methods for ensuring that the M time domain signals of the OFDM signal are non-negative real numbers have drawbacks of high power consumption and/or low spectral efficiency. To improve the spectral efficiency without increasing the power consumption while ensuring that a baseband signal of the OFDM signal is a non-negative real number, this application provides a signal transmission method. A new air interface signal transmission waveform is designed without the direct current bias, to improve the spectral efficiency.

In addition, to facilitate understanding of embodiments of this application, the following several descriptions are provided.

First, in this application, “being used to indicate” may include “being used to directly indicate” and “being used to indirectly indicate”. When a piece of indication information is described as being used to indicate A, the indication information may be used to directly indicate A or used to indirectly indicate A, but it does not necessarily mean that the indication information includes A.

Information indicated by the indication information is referred to as to-be-indicated information. In an implementation process, there are a plurality of manners of indicating the to-be-indicated information, for example, but not limited to, a manner of directly indicating the to-be-indicated information. For example, the to-be-indicated information is indicated by using the to-be-indicated information or an index of the to-be-indicated information. Alternatively, the to-be-indicated information may be indirectly indicated by indicating other information, and there is an association relationship between the other information and the to-be-indicated information. Alternatively, only a part of the to-be-indicated information may be indicated, and the other part of the to-be-indicated information is known or pre-agreed on. For example, information may alternatively be indicated by using an arrangement sequence of a plurality of pieces of information that is pre-agreed on (for example, stipulated in a protocol), to reduce indication overheads to some extent. In addition, a common part of all pieces of information may further be identified and indicated in a unified manner, to reduce indication overheads caused by separately indicating same information.

Second, “first”, “second”, and various numerical numbers (for example, “#1” and “#2”) in this application are merely used to distinguish between objects for ease of description, but are not intended to limit the scope of embodiments of this application. For example, different signals are distinguished.

Third, in this application, “preset” may include “indicated by a transmitter by using signaling” or “predefined”, for example, “defined in a protocol”. “Pre-definition” may be implemented by prestoring corresponding code or a corresponding table in a device (for example, including a transmitter or a receiver), or in another manner that may be used to indicate related information. An implementation is not limited in this application.

Fourth, “storage” in embodiments of this application may be storage in one or more memories. The one or more memories may be separately disposed, or may be integrated into an encoder or a decoder, a processor, or a communication apparatus. Alternatively, some of the one or more memories may be separately disposed, and some of the one or more memories are integrated into a decoder, a processor, or a communication apparatus. A type of the memory may be a storage medium in any form. This is not limited in this application.

The following describes in detail the signal transmission method provided in embodiments of this application with reference to the accompanying drawings.

It should be understood that the signal transmission method provided in embodiments of this application may be applied to the signal transmission system 100 shown in FIG. 1. The signal transmission system may include at least one transmitter and at least one receiver. The transmitter may communicate with the receiver by using an optical fiber.

It should further be understood that a structure of an entity for performing the method provided in embodiments of this application is not specially limited in the following embodiments, provided that a program that records code for the method provided in embodiments of this application can be run to perform communication according to the method provided in embodiments of this application. For example, the method provided in embodiments of this application may be performed by a transmitter and a receiver, or a functional module in the transmitter and the receiver that can execute the program.

Without loss of generality, the following describes in detail the signal transmission method provided in embodiments of this application by using interaction between the transmitter and the receiver as an example.

FIG. 7 is a schematic flowchart of a signal transmission method according to an embodiment of the application. The method is performed by a transmitter and a receiver. As shown in FIG. 7, the method 700 includes at least some of the following operations.

S710: The transmitter obtains 2^{N} first signals and 2^{N}−1 second signals.

Specifically, each first signal in the 2^{N} first signals includes M signal points, each second signal in the 2^{N}−1 second signals includes M signal points, N is a positive integer, M is a positive even number, a signal value, at an even location, of the M signal points of the first signal is 0, and a signal value, at an odd location or an even location, of the M signal points of the second signal is 0. It should be noted that all second signals in the 2^{N}−1 second signals may be the second signals in which the signal value, at the odd location, of the M signal points is 0, all second signals in the 2^{N}−1 second signals may be the second signals in which with the signal value, at the even location, of the M signal points is 0, and the 2^{N}−1 second signals may include at least one second signal in which the signal value, at the odd location, of the M signal points is 0 and at least one second signal in which the signal value, at the even location, of the M signal points is 0. It should be noted that locations of the M signal points are sorted from 0, that is, an index value m starts from 0. For example, a location, namely, an index value, of a 1^{st} signal point is 0, namely, the even location. For another example, a location, namely, an index value, of a 2^{nd} signal point is 1, namely, the odd location.

It should be understood that information carried by all first signals in the 2^{N} first signals may be the same or different, and information carried by all second signals in the 2^{N}−1 second signals may be the same or different. This is not limited in embodiments of this application.

In an embodiment, the 2^{N} first signals and the 2^{N}−1 second signals may be to-be-transmitted signals that are externally input to the transmitter.

In an embodiment, the 2^{N} first signals and the 2^{N}−1 second signals may be signals respectively obtained after the transmitter deletes signal points from or adds the signal points to signals that are externally input to the transmitter. As an example instead of a limitation, the transmitter receives 2^{N+1}−1 signals that are externally input, where the signal includes M+w signal points, and the transmitter may delete first w signal points, last m signal points, or any w signal points of each signal, to obtain the 2^{N} first signals and the 2^{N}−1 second signals. As an example instead of a limitation, the transmitter receives 2^{N+1}−1 signals that are externally input, where the signal includes M-w signal points, and the transmitter may add w signal points before a signal point of each signal, add w signal points after a signal point of each signal, or add w signal points at any location of each signal, to obtain the 2^{N} first signals and the 2^{N}−1 second signals, provided that a limitation that values, at the odd and even locations, of the first signal and the second signal are 0 is met. It should be noted that, in an embodiment of the application, a location of a signal added or deleted by the transmitter is not limited, and how to add or delete a signal is not limited either.

In an embodiment, the 2^{N} first signals and the 2^{N}−1 second signals may be obtained by setting signals that are externally input to the transmitter to 0 at an odd location or an even location.

It should be understood that the foregoing is merely an example for describing how to obtain the 2^{N} first signals and the 2^{N}−1 second signals, and constitutes no limitation on the protection scope of this application. In an embodiment of the application, the transmitter may alternatively obtain the 2^{N} first signals and the 2^{N}−1 second signals in another manner.

In some embodiments, the 2^{N} first signals and the 2^{N}−1 second signals are frequency domain signals of an electrical OFDM signal.

In some embodiments, the 2^{N} first signals and the 2^{N}−1 second signals are time domain signals of an electrical OFDM signal.

It should be noted that types of the 2^{N} first signals and the 2^{N}−1 second signals are not particularly limited in embodiments of this application, provided that the 2^{N} first signals and the 2^{N}−1 second signals are signals that meet symmetry.

The following provides an example. It should be understood that this example constitutes no limitation on the solution in embodiments of this application.

In this example, a value of N is 1, and 2^{N} first signals and the 2^{N}−1 second signals are frequency domain signals of an electrical OFDM signal.
A 1^{st} first signal is (0, X(1), 0, X(3), . . . , 0, X(M−1));
a 2^{nd} first signal is (0, X′(1), 0, X′(3), . . . , 0, X′(M−1); and
the second signal is (X(0), 0, X(2), 0, . . . , X(M−2), 0)).

It should be understood that the 1st first signal and the second signal may be a same signal obtained by setting an odd location and an even location to 0, or may be two different signals. Symbols and numbers used in this example constitute no limitation on a source of a signal. In an embodiment of the application, a value, at the odd location, of the M signal points of the second signal is 0. Alternatively, it should be understood that values, at the even location, of the M signal points of the second signal may be 0.

It should be noted that the 1^{st} first signal and the 2^{nd} first signal herein do not mean to sort the first signals, but are used for distinguishing for ease of description.

S720: The transmitter performs inverse fast Fourier transform IFFT, inverse Fourier transform IFT, fast Fourier transform FFT, or Fourier transform FT on the 2^{N} first signals and the 2^{N}−1 second signals to determine 2^{N} third signals and 2^{N}−1 fourth signals.

Specifically, each third signal in the 2^{N} third signals includes M signal points, and each fourth signal in the 2^{N}−1 fourth signals includes M signal points. The transmitter performs FFT or IFFT on an i^{th} first signal in the 2^{N} first signals to obtain an i^{th} third signal in the 2^{N} third signals, and performs FFT or IFFT on an x^{t}h second signal in the 2^{N}−1 second signals to obtain an x^{th} fourth signal in the 2^{N}−1 fourth signals, where i is a positive integer less than or equal to 2^{N}, and x is a positive integer less than or equal to 2^{N}−1.

It should be noted that statements such as the i^{th} first signal and the i^{th} third signal herein do not limit a sequence of the signals, but are used for distinguishing for clarity of description in this specification, and are intended to indicate that the third signal and the first signal are in a one-to-one correspondence. The following similar statements are all used for distinguishing, and are not described one by one.

In some embodiments, if the first signal and the second signal are frequency domain signals of an electrical OFDM signal, the third signal and the fourth signal that respectively correspond to the first signal and the second signal are time domain signals of the electrical OFDM signal.

In some embodiments, if the first signal and the second signal are time domain signals of an electrical OFDM signal, the third signal and the fourth signal that respectively correspond to the first signal and the second signal are frequency domain signals of the electrical OFDM signal.

In some embodiments, the third signal and the fourth signal are other signals that meet a symmetric characteristic or an antisymmetric characteristic. This is not limited in embodiments of this application.

Specifically, symmetry means that signal values corresponding to the last M/2 signal points of the signal are the same as signal values corresponding to the first M/2 signal points. Antisymmetry means that the signal values corresponding to the last M/2 signal points and the signal values corresponding to the first M/2 signal points of the signal are the same in absolute values but opposite in signs.

It should be noted that the third signal meets the antisymmetric characteristic. The fourth signal determined based on the second signal whose value, at the even location, of the M signal points is 0 meets the antisymmetric characteristic, and the fourth signal determined based on the second signal whose value, at the odd location, of the M signal points is 0 meets the symmetric characteristic.

Corresponding to the example given in operation S710, the third signal and the fourth signal that are respectively obtained after IFFT, IFT, FFT, or FT is performed on the first signal and the second signal are the time domain signals of the electrical OFDM signal.

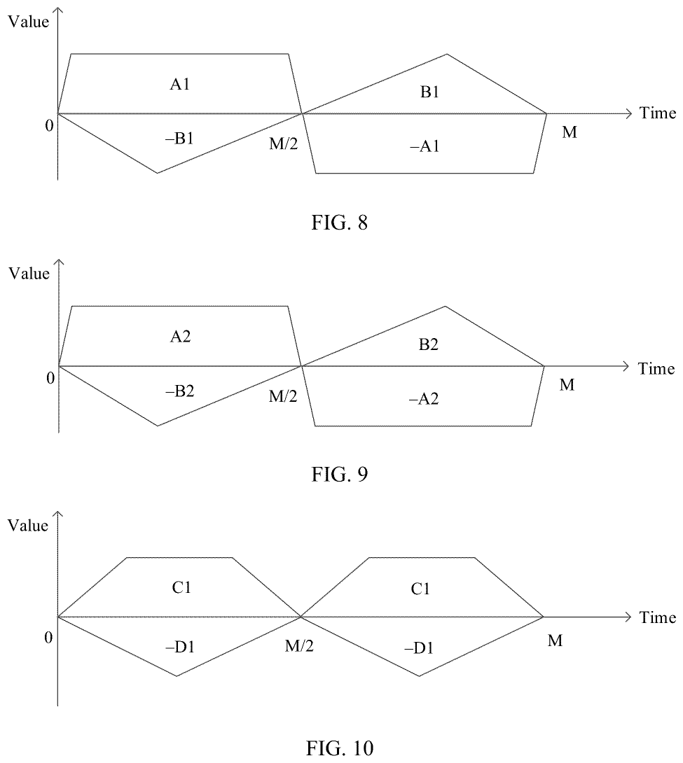

As shown in FIG. 8, a 1^{st} third signal (xo(0), xo(1), xo(2), xo(3), . . . , xo(M−1)) is obtained by performing FFT or IFFT on the 1^{st} first signal. FIG. 8 is an example of the third signal that meets the antisymmetric characteristic according to an embodiment of this application.

As shown in FIG. 9, a 2^{nd} third signal (x′o(0), x′o(1), x′o(2), x′o(3), . . . , x′o(M−1)) is obtained by performing IFFT, IFT, FFT, or FT on the 2^{nd} first signal. FIG. 9 is another example of the third signal that meets the antisymmetric characteristic according to an embodiment of this application.

As shown in FIG. 10, a fourth signal (xe(0), xe(1), xe(2), xe(3), . . . , xe(M−1)) is obtained by performing IFFT, IFT, FFT, or FT on the second signal. FIG. 10 is an example of the fourth signal that meets the symmetric characteristic according to an embodiment of this application.

It should be noted that FIG. 8, FIG. 9, and FIG. 10 are all diagrams of time domain signals of electrical OFDM signals that meet the HS constraint, and the HS constraint is not described in detail herein.

S730: The transmitter determines a fifth signal based on the 2^{N} third signals and the 2^{N}−1 fourth signals.

Specifically, that the transmitter determines the fifth signal based on the 2^{N} third signals and the 2^{N}−1 fourth signals includes the following operations, which are separately described below.

### Operation 1:

The transmitter determines 2^{N} sixth signals and 2^{N} seventh signals based on the 2^{N} third signals, and determines 2^{N}−1 eighth signals and 2^{N}−1 ninth signals based on the 2^{N}−1 fourth signals.

Specifically, for the third signal that meets the antisymmetric characteristic, an i^{th} sixth signal is obtained by setting a signal value that is less than 0 and that corresponds to the first M/2 signal points of the i^{th} third signal, or an i^{th} sixth signal is obtained by setting a signal value that is greater than 0 and that corresponds to the last M/2 signal points of the i^{th} third signal to 0 and calculating an absolute value of a signal value that is less than 0 and that corresponds to the last M/2 signal points of the i^{th} third signal; and
an i^{th} seventh signal is obtained by setting the signal value that is less than 0 and that corresponds to the last M/2 signal points of the i^{th} third signal, or an i^{th} seventh signal is obtained by setting a signal value that is greater than 0 and that corresponds to the first M/2 signal points of the i^{th} third signal to 0 and calculating an absolute value of the signal value that is less than 0 and that corresponds to the first M/2 signal points of the i^{th} third signal.

Specifically, for the fourth signal that meets the antisymmetric characteristic, namely, the fourth signal determined based on the second signal with a value of 0 at an even location, an x^{th} eighth signal is obtained by setting a signal value that is less than 0 and that corresponds to the first M/2 signal points of the x^{th} fourth signal, or an x^{th} eighth signal is obtained by setting a signal value that is greater than 0 and that corresponds to the last M/2 signal points of the x^{th} fourth signal to 0 and calculating an absolute value of a signal value that is less than 0 and that corresponds to the last M/2 signal points of the x^{th} fourth signal; and
an x^{th} ninth signal is obtained by setting the signal value that is less than 0 and that corresponds to the last M/2 signal points of the x^{th} fourth signal, or an x^{th} ninth signal is obtained by setting a signal value that is greater than 0 and that corresponds to the first M/2 signal points of the x^{th} fourth signal to 0 and calculating an absolute value of the signal value that is less than 0 and that corresponds to the first M/2 signal points of the x^{th} fourth signal.

Specifically, for the fourth signal that meets the symmetric characteristic, namely, the fourth signal determined based on the second signal with a value of 0 at an odd location, an x^{th} eighth signal is obtained by setting a signal value that is less than 0 and that corresponds to the first M/2 signal points of the x^{th} fourth signal, or an x^{th} eighth signal is obtained by setting a signal value that is greater than 0 and that corresponds to the last M/2 signal points of the x^{th} fourth signal to 0 and calculating an absolute value of a signal value that is less than 0 and that corresponds to the last M/2 signal points of the x^{th} fourth signal; and
an x^{th} ninth signal is obtained by setting the signal value that is less than 0 and that corresponds to the last M/2 signal points of the x^{th} fourth signal, or an x^{th} ninth signal is obtained by setting a signal value that is greater than 0 and that corresponds to the first M/2 signal points of the x^{th} fourth signal to 0 and calculating an absolute value of the signal value that is less than 0 and that corresponds to the first M/2 signal points of the x^{th} fourth signal.

This corresponds to the example in the foregoing operations.

In FIG. 8, for the first M/2 signal points of the 1^{st} third signal, a part greater than or equal to 0 is defined as A1, and a part less than 0 is defined as −B1. For the last M/2 signal points, a part greater than or equal to 0 is defined as B1, and a part less than 0 is defined as −A1. Both A1 and B1 are signals greater than 0. A1 and B1 may be obtained, namely, a 1^{st} sixth signal and a 1^{st} seventh signal that correspond to the 1^{st} third signal in this example.

Specifically, the 1^{st} third signal is (xo(0), xo(1), xo(2), xo(3), . . . , xo(M−1)), and the 1st third signal meets the antisymmetric characteristic, that is, xo(m)=−xo(M/2+m). In this case, A1 is a positive value part of a signal value of a signal point with an index value of 0 to M/2-1 of the 1^{st} third signal, or A1 is an absolute value of a negative value part of a signal value of a signal point with an index value of M/2 to M−1 of the 1^{st} third signal.

Specifically, the 1st third signal is (xo(0), xo(1), xo(2), xo(3), . . . , xo(M−1)), and the 1^{st} third signal meets the antisymmetric characteristic, that is, xo(m)=−xo (M12+m). In this case, B1 is an absolute value of a negative value part of the signal value of the signal point with the index value of 0 to M/2-1 of the 1st third signal, or B1 is a positive value part of the signal value of the signal point with the index value of M/2 to M−1 of the 1st third signal.

When A1 is the positive value part of the signal value of the signal point with the index value of 0 to M/2−1 of the 1st third signal, A1=A1(0), A1(1), . . . , A1(M/2-1), where when xo(m)≥0, A1(m)=xo(m), and when xo(m)<0, A1(m)=0. When A1 is the absolute value of the negative value part of the signal value of the signal point with the index value of M/2 to M−1 of the 1st third signal, A1=A1(M/2), A1(M/2+1), . . . , A1(M−1), where when xo(m)≥0, A1(m)=0, and when xo(m)<0, A1(m)=−xo(m).

When B1 is the absolute value of the negative value part of the signal value of the signal point with the index value of 0 to M/2−1 of the 1st third signal, B1=B1(0), B1(1), . . . , B1(M/2-1), where when xo(m)≥0, B1(m)=0, and when xo(m)<0, B1(m)=−xo(m). When B1 is the positive value part of the signal value of the signal point with the index value of M/2 to M−1 of the 1st third signal, B1=B1(M/2), B1(M/2+1), . . . , B1(M−1), where when xo(m)≥0, B1(m)=xo(m), and when xo(m)<0, B1(m)=0.

In FIG. 9, for the first M/2 signal points of, a part greater than or equal to 0 is defined as A2, and a part less than 0 is defined as −B2. For the last M/2 signal points, a part greater than or equal to 0 is defined as B2, and a part less than 0 is defined as −A2. Both A2 and B2 are signals greater than 0. A2 and B2 may be obtained, namely, a 2^{nd} sixth signal and a 2^{nd} seventh signal that correspond to the 2^{nd} third signal in this example.

A method for obtaining A2 and B2 is similar to the method for obtaining A1 and B1. Refer to the method for obtaining A1 and B1. Details are not described herein again.

In FIG. 10, for the first M/2 signal points or the last M/2 signal points, a part greater than or equal to 0 is defined as C1, and a part less than 0 is defined as −D1. Both C1 and D1 are signals greater than 0. C1 and D1 may be obtained, namely, the eighth signal and the ninth signal that correspond to the second signal in this example.

Specifically, the fourth signal is (xe(0), xe(1), xe(2), xe(3), . . . , xe(M−1)), and the fourth signal meets the symmetric characteristic. In other words, xe(m)=xe(M12+m). In this case, C1 is a positive value part of a signal value of a signal point with an index value of 0 to M/2−1 or a positive value part of a signal value of a signal point with an index value of M/2 to M−1 of the fourth signal, and D1 is an absolute value of a negative value part of the signal value of the signal point with the index value of 0 to M/2−1 or an absolute value of a negative value part of the signal value of the signal point with the index value of M/2 to M−1 of the fourth signal.

When C1 is the positive value part of the signal value of the signal point with the index value of 0 to M/2−1 or the positive value part of the signal value of the signal point with the index value of M/2 to M−1 of the fourth signal, C1=C1(0), C1(1), . . . , C1(M/2−1), or C1=C1(M/2), C1(M/2+1), . . . , C1(M−1), where when xe(m)≥0, C1(m)=xe(m), and when xe(m)<0, C1(m)=0. When D1 is the absolute value of the negative value part of the signal value of the signal point with the index value of 0 to M/2−1 or the absolute value of the negative value part of the signal value of the signal point with the index value of M/2 to M−1 of the fourth signal, D1=D1(0), D1(1), . . . , D1(M/2−1), or D1=D1(M/2), D1(M/2+1), . . . , D1(M−1), where when xe(m)≥0, D1(m)=0, and when xe(m)<0, D1(m)=−xe(m).

### Operation 2:

The transmitter determines the fifth signal based on the 2^{N} sixth signals, the 2^{N} seventh signals, the 2^{N}−1 eighth signals, and the 2^{N}−1 ninth signals.

Specifically, the transmitter performs a signal mixing operation. A mixed signal obtained by the transmitter is the fifth signal, and the fifth signal includes M*2^{N} signal points. How to determine the M*2^{N} signal points included in the fifth signal is described in detail below.

The M*2^{N} signal points may be grouped into 2^{N} groups of signal points, where each group of signal points includes M signal points, and each group of signal points may further include two M/2 signal points. It should be noted that there is no sequence in transmitting the two M/2 signal points included in each group of signal points, that is, the transmission over an air interface is not necessarily performed at adjacent time, and transmission of M/2 signal points included in another group of signal points may be interspersed. In an embodiment of the application, an embodiment of the application is explained with reference to an example, for better understanding.

The following uses one group of signal points as an example to describe determining of the M*2^{N} signal points of the fifth signal.

It should be noted that the group of signal points corresponds to one first signal, and the 2^{N} groups of signal points included in the fifth signal respectively correspond to the 2^{N} first signals. One group of signal points corresponding to the i^{th} first signal is used for description herein. It should be noted that a transmission sequence of the 2^{N} groups of signal points of the fifth signal does not correspond to i of the i^{th} first signal. In addition, similar to the foregoing explanation, the i^{th} first signal does not indicate a sequence.

Specifically, M/2 signal points in the group of signal points corresponding to the i^{th} first signal are determined based on the i^{th} sixth signal determined based on the i^{th} first signal and an i^{th} signal combination, and the other M/2 signal points in the group of signal points corresponding to the i^{th} first signal are determined based on the i^{th} seventh signal determined based on the i^{th} first signal and the i^{th} signal combination. It should be noted that the M/2 signal points are sent in sequence, and the other M/2 signal points are also sent in sequence. M/2 signal points and the other M/2 signal points in a same group of signal points are determined based on a same signal combination. It should be particularly noted that i in the i^{th} signal combination does not indicate a sequence, and is merely used to indicate that the group of signal points corresponds to the i^{h} first signal.

It should be noted that the i^{th} signal combination is determined based on at least N eighth signals and/or ninth signals. In an embodiment, the i^{th} signal combination may be determined based on the at least N eighth signals, and the at least N eighth signals are determined based on at least N fourth signals. In an embodiment, the i^{th} signal combination may be determined based on the at least N ninth signals, and the at least N ninth signals are determined based on at least N fourth signals. In an embodiment, the i^{th} signal combination may be determined based on the eighth signal and the ninth signal, and a total quantity of the i^{th} signal combination is at least N.

It should be noted that the eighth signal and the ninth signal that determine the i^{th} signal combination cannot be determined based on a same fourth signal, that is, the case does not exist: The at least N eighth signals and/or ninth signals that determine the i^{th} signal combination include the x^{th} eighth signal and the x^{th} ninth signal.

A signal value of the M/2 signal points in the group of signal points is a sum of a signal value of a signal point corresponding to the corresponding i^{th} sixth signal and a signal value of a signal point corresponding to the at least N eighth signals and/or ninth signals included in the i^{th} signal combination. A signal value of the other M/2 signal points in the group of signal points is a sum of a signal value of a signal point corresponding to the corresponding i^{th} seventh signal and the signal value of the signal point corresponding to the at least N eighth signals and/or ninth signals included in the i^{th} signal combination. Embodiments of this application are described in detail with reference to the following example, so that a reader can better understand the solution disclosed in embodiments of this application.

It should be noted that all eighth signals and ninth signals corresponding to the 2^{N} signal combinations include the 2^{N}−1 eighth signals and the 2^{N}−1 ninth signals determined based on the 2^{N}−1 fourth signals.

Corresponding to the foregoing example, the fifth signal is determined based on the 2^{N} third signals and the 2^{N}−1 fourth signals. The fifth signal includes M*2^{N} signal points, that is, includes two groups of signal points. The following describes the fifth signal determined in this example by using the foregoing method.

In this example, N=1, and only one second signal is input. Therefore, the signal combination includes one eighth signal or ninth signal, that is, C1 or D1.

In a possible mixing manner, a signal value of M/2 signal points in one group of signal points of the fifth signal is a sum of a signal value of a signal point corresponding to the 1^{st} sixth signal determined based on the 1^{st} first signal and a signal value of a signal point corresponding to the eighth signal, that is, A1+C1. A signal value of the other M/2 signal points is a sum of a signal value of a signal point corresponding to the 1^{st} seventh signal determined based on the 1^{st} first signal and the signal value of the signal point corresponding to the eighth signal, that is, B1+C1. A signal value of M/2 signal points in the other group of signal points of the fifth signal is a sum of a signal value of a signal point corresponding to the 2^{nd} sixth signal determined based on the 2^{nd} first signal and a signal value of a signal point corresponding to the ninth signal, that is, A2+D1. A signal value of the other M/2 signal points is a sum of a signal value of a signal point corresponding to the 2^{nd} seventh signal determined based on the 2^{nd} first signal and the signal value of the signal point corresponding to the ninth signal, that is, B2+D1.

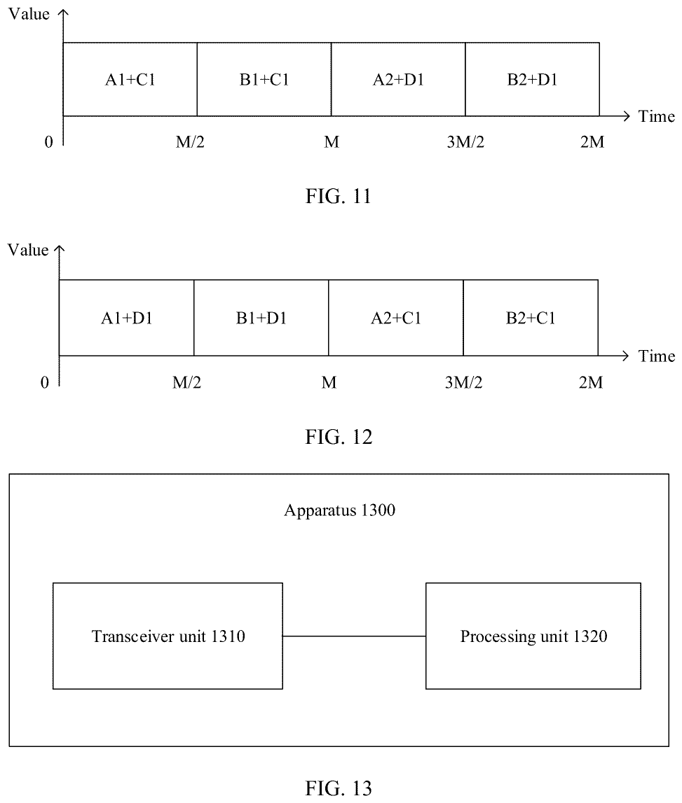

The fifth signal may be (A1+C1), (B1+C1), (A2+D1), and (B2+D1), where each parenthesis includes M/2 signal points. As shown in FIG. 11, FIG. 11 shows an example of an air interface signal corresponding to the fifth signal according to an embodiment of this application. It should be understood that a transmission sequence of (A1+C1), (B1+C1), (A2+D1), and (B2+D1) is adjustable. For example, the transmission sequence of the fifth signal may be (A1+C1), (A2+D1), (B2+D1), and (B1+C1), may be (B2+D1), (A1+C1), (B1+C1), and (A2+D1), or the like. This is not limited in this application.

In a possible mixing manner, a signal value of M/2 signal points in one group of signal points of the fifth signal is a sum of the signal value of the signal point corresponding to the 1^{st} sixth signal determined based on the 1^{st} first signal and the signal value of the signal point corresponding to the ninth signal, that is, A1+D1. A signal value of the other M/2 signal points is a sum of the signal value of the signal point corresponding to the 1^{st} seventh signal determined based on the 1^{st} first signal and the signal value of the signal point corresponding to the ninth signal, that is, B1+D1. A signal value of M/2 signal points in the other group of signal points of the fifth signal is a sum of the signal value of the signal point corresponding to the 2^{nd} sixth signal determined based on the 2^{nd} first signal and the signal value of the signal point corresponding to the eighth signal, that is, A2+C1. A signal value of the other M/2 signal points is a sum of the signal value of the signal point corresponding to the 2^{nd} seventh signal determined based on the 2^{nd} first signal and the signal value of the signal point corresponding to the eighth signal, that is, B2+C1.

The fifth signal may be (A1+D1), (B1+D1), (A2+C1), and (B2+C1), where each parenthesis includes M/2 signal points. As shown in FIG. 12, FIG. 12 shows another example of an air interface signal corresponding to the fifth signal according to an embodiment of this application. It should be understood that a transmission sequence of (A1+D1), (B1+D1), (A2+C1), and (B2+C1) is adjustable. For example, the transmission sequence of the fifth signal may be (A1+D1), (A2+C1), (B2+C1), and (B1+D1), may be (B2+C1), (A1+D1), (B1+D1), and (A2+C1), or the like. This is not limited in this application.

For example, the sixth signal, the seventh signal, the eighth signal, and the ninth signal are time domain signals, and (A1+C1), (B1+C1), (A2+D1), and (B2+D1), or (A1+D1), (B1+D1), (A2+C1), and (B2+C1) may be obtained by mixing the time domain signals, to output the fifth signal.

S740: The transmitter transmits the fifth signal to the receiver, and correspondingly, the receiver receives the fifth signal sent by the transmitter.

The transmitter transmits the fifth signal to the receiver, and correspondingly, the receiver receives the fifth signal sent by the transmitter. As described in operation S730, the fifth signal includes the M*2^{N} signal points, and the M*2^{N} signal points may be grouped into 2^{N} groups. Each group of signal points corresponds to one first signal and one signal combination.

In an embodiment, the transmitter may notify, by using signaling, the receiver of a transmission sequence of a mixed signal of the fifth signal, and the one first signal and the one signal combination corresponding to each group of signal points, so that the receiver demodulates on the signal after receiving the fifth signal.

In an embodiment, when sending the fifth signal, the transmitter may carry, in each signal point of the fifth signal, index values that are of the sixth signal, the seventh signal, the eighth signal, and the ninth signal and that determine the signal point, so that the receiver demodulates on the signal after receiving the fifth signal.

A method for notifying the receiver of a signal mixing manner by the transmitter is not particularly limited in an embodiment of the application, provided that the receiver can determine the signal mixing manner and demodulate the fifth signal.

S750: The receiver performs IFFT, IFT, FFT, or FT on the fifth signal to determine the 2^{N} first signals and the 2^{N}−1 second signals.

Specifically, that the receiver performs IFFT, IFT, FFT, or FT on the fifth signal to determine the 2^{N} first signals and the 2^{N}−1 second signals includes the following operations, which are described operation by operation below.

### Operation 1:

The receiver receives the fifth signal, where the fifth signal includes the M*2^{N} signal points. As described in the foregoing operation, the M*2^{N} signal points are transmitted by using 2^{N+1} M/2 signal points. A transmission sequence of the 2^{N+1} M/2 signal points is not limited.

The receiver receives the fifth signal, and classifies the M*2^{N} signal points into the 2^{N} groups of signal points in the signal mixing manner obtained from the transmitter, where each group of signal points corresponds to one first signal and one signal combination.

Corresponding to the foregoing example, a sequence of transmitting the signal points of the fifth signal over the air interface is (A1+D1), (A2+C1), (B2+C1), and (B1+D1).

The receiver receives the fifth signal (A1+D1), (A2+C1), (B2+C1), and (B1+D1), and groups the 2*M signal points of the fifth signal into two groups in the signal mixing manner, where one group is (A1+D1) and (B1+D1), and the other group is (A2+C1) and (B2+C1).

### Operation 2:

The receiver performs the IFFT, IFT, FFT, or FT operation on each group of signal points of the fifth signal, to determine the 2^{N} first signals respectively corresponding to the 2^{N} groups of signal points.

Specifically, the receiver performs the IFFT, IFT, FFT, or FT operation on each group of signal points, to obtain a frequency domain signal with interference of the first signal corresponding to each group of signal points, and performs compensation and zero setting on the frequency domain signal with interference. The first signal corresponding to each group of signal points may be obtained. An implementation method is described with reference to an example.

Corresponding to the foregoing example, the IFFT or FFT operation is performed on M signal points in the group of signal points (A1+D1) and (B1+D1), to obtain a frequency domain signal h/2*[˜, X(1), ˜, X(3), . . . , 0, X(M−1)], where ˜ is a useless signal, h/2 is a constant signal introduced by a factor like a channel, and compensation is performed for h/2 of the frequency domain signal. For example, an output is divided by h/2, and an even location is set to zero. In this case, the 1^{st} first signal (0, X(1), 0, X(3), . . . , 0, X(M−1)) corresponding to A1 and B1 may be obtained.

The IFFT or FFT operation is performed on M signal points of the other group of signal points (A2+C1) and (B2+C1), to obtain a frequency domain signal h/2*[˜, X′(1), ˜, X′(3), . . . , 0, X′(M−1)], where ˜ is a useless signal, h/2 is a constant signal introduced by a factor like a channel, and compensation is performed for h/2 of the frequency domain signal. For example, an output is divided by h/2, and an even location is set to zero. In this case, the 2^{nd} first signal (0, X′(1), 0, X′(3), . . . , 0, X′(M−1)) corresponding to A2 and B2 may be obtained.

### Operation 3:

The receiver performs the IFFT, IFT, FFT, or FT operation on the 2^{N} first signals respectively corresponding to the 2^{N} groups of signal points, to determine the signal combination corresponding to each group of signal points.

Specifically, one group of signal points is used as an example. The receiver performs the IFFT, IFT, FFT, or FT operation on a first signal corresponding to the group of signal points, to obtain a third signal corresponding to the first signal, obtains, according to the method provided in operation 1 in operation S730, a sixth signal and/or a seventh signal corresponding to the third signal, and determines the signal combination based on M/2 signal points of the group of signal points and the sixth signal, or determines the signal combination based on the other M/2 signal points of the group of signal points and the seventh signal.

Specifically, a sum of signal values, at corresponding locations, of signal points of at least N signals included in the signal combination is a signal value corresponding to the M/2 signal points of the group of signal points minus a signal value of a signal point corresponding to the sixth signal.

Corresponding to the foregoing example, the 1^{st} first signal (0, X(1), 0, X(3), . . . , 0, X(M−1)) corresponding to the group of signal points (A1+D1) and (B1+D1) is obtained. The receiver performs IFFT, IFT, FFT, or FT on the 1^{st} first signal to obtain the 1^{st} third signal. According to the method provided in operation 2 in operation S730, A1 and/or B1 may be obtained. Based on A1 and/or B1 and (A1+D1) and/or (B1+D1) received by the receiver, difference calculation is performed on signal values of signal points at corresponding locations, to obtain D1. It should be noted that, to obtain D1, only any one of A1 and B1 needs to be obtained, or both A1 and B1 may be obtained. This is not limited in this embodiment of this application.

Similar to the foregoing method, C1 may be obtained. Details are not described herein again.

It should be noted that, in this example, because there is only one second signal, C1 and D1 may be obtained separately. In some embodiments, there is more than one second signal, and a sum of a part of C and a part of D, the part of C, and the part of D may be obtained. After all the operations in the method 700 are described, an example in which N is greater than 1 is provided in the specification of this application. A reader may have a deeper understanding of the solution described in the method 700 with reference to the example.

### Operation 4:

The receiver determines a maximum of 2^{N}−1 eighth signals, a maximum of 2^{N}−1 ninth signals, and a relationship between the maximum of 2^{N}−1 eighth signals and the maximum of 2^{N}−1 ninth signals based on the 2^{N} signal combinations, and determines the 2^{N}−1 fourth signals by performing the IFFT, IFT, FFT, or FT operation based on the maximum of 2^{N}−1 eighth signals, the maximum of 2^{N}−1 ninth signals, and the relationship between the maximum of 2^{N}−11 eighth signals and the maximum of 2^{N}−1 ninth signals.

It should be noted that this operation needs to be described with reference to an example in which N is greater than 1, and a reader may understand this operation with reference to the example in which N is greater than 1.

Corresponding to the foregoing example, after C1 and D1 are determined, C1-D1, that is, a value of the first M/2 signal points of one fourth signal or a value of the last M/2 signal points of the fourth signal in this example may be determined based on C1 and D1. Further, the fourth signal is obtained, and the IFFT, IFT, FFT, or FT operation is performed on the fourth signal to obtain the second signal in this example.

A signal value is substituted into the foregoing example for description below, so that a reader can better understand the solution provided in the method 700.

(1) The transmitter obtains the 1^{st} first signals, where M=8, and the 1^{st} first signal is shown in Table 1.

TABLE 1
1^{st} first signal, where M = 8

| | | | | | | | |
|---|---|---|---|---|---|---|---|
| 0 | −3 − j | 0 | −1 + 3j | 0 | −3 − j | 0 | −3 + j |

The transmitter obtains the 2^{nd} first signal, where M=8, and the 2^{nd} first signal is shown in Table 2.

TABLE 2
2^{nd} first signal, where M = 8

| | | | | | | | |
|---|---|---|---|---|---|---|---|
| 0 | 1 − j | 0 | 1 − 3j | 0 | 1 + 3j | 0 | 1 + j |

The transmitter obtains the second signal, where M=8, and the second signal is shown in Table 3.

TABLE 3
Second signal, where M = 8

| | | | | | | | |
|---|---|---|---|---|---|---|---|
| 0 | 0 | −3 + j | 0 | 0 | 0 | −3 − j | 0 |

(2) The transmitter performs the IFFT, IFT, FFT, or FT operation on the 1^{st} first signal, the 2^{nd} first signal, and the second signal, to obtain the 1^{st} third signal, the 2^{nd} third signal, and the fourth signal, as shown in Table 4, Table 5, and Table 6, where M=8.

TABLE 4
1^{st} third signal, where M = 8

| | | | | | | | |
|---|---|---|---|---|---|---|---|
| −1 | −0.707 | 1 | 0 | 1 | 0.707 | −1 | 0 |

TABLE 5
2^{nd} third signal, where M = 8

| | | | | | | | |
|---|---|---|---|---|---|---|---|
| 0.5 | 0.707 | −0.5 | 0.707 | −0.5 | −0.707 | 0.5 | −0.707 |

TABLE 6
Fourth signal, where M = 8

| | | | | | | | |
|---|---|---|---|---|---|---|---|
| −0.75 | −0.25 | 0.75 | 0.25 | −0.75 | −0.25 | 0.75 | 0.25 |

(3) A1, B1, A2, B2, C1, and C2 are obtained based on the antisymmetric characteristic of the third signal and the symmetric characteristic of the fourth signal, as shown in Table 7, Table 8, and Table 9.

TABLE 7

| | | | | |
|---|---|---|---|---|
| A1 | 0 | 0 | 1 | 0 |
| B1 | 1 | 0.707 | 0 | 0 |

TABLE 8

| | | | | |
|---|---|---|---|---|
| A2 | 0.5 | 0.707 | 0 | 0.707 |
| B2 | 0 | 0 | 0.5 | 0 |

TABLE 9

| | | | | |
|---|---|---|---|---|
| C1 | 0 | 0 | 0.75 | 0.25 |
| D1 | 0.75 | 0.25 | 0 | 0 |

(4) The signals are mixed, and the fifth signal sent over the air interface is (A1+C1), (B1+C1), (A2+D1), and (B2+D1), or (A1+D1), (B1+D1), (A2+C1), and (B2+C1), and the sequence is adjustable. For example, the fifth signal sent over the air interface is (A1+C1), (B1+C1), (A2+D1), and (B2+D1), where values of (A1+C1), (B1+C1), (A2+D1), and (B2+D1) are shown in Table 10.

TABLE 10

| | | | | |
|---|---|---|---|---|
| A1 + C1 | 0 | 0 | 1.75 | 0.25 |
| B1 + C1 | 1 | 0.707 | 0.75 | 0.25 |
| A2 + D1 | 1.25 | 0.9571 | 0 | 0.707 |
| B2 + D1 | 0.75 | 0.25 | 0.5 | 0 |

(5) The transmitter transmits the fifth signal, and correspondingly, the receiver receives the fifth signal transmitted by the transmitter, namely (A1+C1), (B1+C1), (A2+D1), and (B2+D1).

(6) The receiver obtains two groups of separated signal points by performing a signal separation operation, as shown in Table 11 and Table 12.

TABLE 11
One group of signal points corresponding
to the 1^{st} first signal, where M = 8

| | |
|---|---|
| (A1 + C1) | (B1 + C1) |

| | | | | | | | |
|---|---|---|---|---|---|---|---|
| 0 | 0 | 1.75 | 0.25 | 1 | 0.707 | 0.75 | 0.25 |

TABLE 12
One group of signal points corresponding
to the 2^{nd} first signal, where M = 8

| | |
|---|---|
| (A2 + D1) | (B2 + D1) |

| | | | | | | | |
|---|---|---|---|---|---|---|---|
| 1.25 | 0.9571 | 0 | 0.707 | 0.75 | 0.25 | 0.5 | 0 |

(7) The receiver performs the IFFT, IFT, FFT, or FT operation on the group of signal points corresponding to the 1^{st} first signal, to obtain the third signal, as shown in Table 13, and performs the IFFT, IFT, FFT, or FT operation on the group of signal points corresponding to the 2^{nd} first signal, to obtain the 2^{nd} third signal, as shown in Table 14.

TABLE 13
IFFT, IFT, FFT, or FT operation is performed on the
group of signal points corresponding to the 1^{st} first signal, where M = 8

| | | | | | | | |
|---|---|---|---|---|---|---|---|
| 4.7071 + j | −1.5 − 0.5j | −1.5 − 0.2071j | −0.5 + 1.5j | 2.2929 + 1j | −0.5 − 1.5j | −1.5 + 0.2071j | −1.5 + 0.5j |

Compensation is performed for h/2 of the factor like the channel,
and the even location is set to zero, to obtain the 1^{st} first signal, where M = 8

| | | | | | | | |
|---|---|---|---|---|---|---|---|
| 0 | −3 − j | 0 | −1 + 3j | 0 | −1 − 3j | 0 | −3 + j |

It should be noted that, when the compensation is performed for h/2 of the factor like the channel in Table 13, the signal obtained after the IFFT, IFT, FFT, or FT operation is performed on the group of signal points corresponding to the 1^{st} first signal is multiplied by 2, to compensate for the factor like the channel. It should be understood that h/2 may be another value through the compensation. This is merely an example herein, and is not particularly limited.

TABLE 14
IFFT, IFT, FFT, or FT operation is performed on the
group of signal points corresponding to the 2^{nd} first signal, where M = 8

| | | | | | | | |
|---|---|---|---|---|---|---|---|
| 4.4142 | 0.5 − 0.5j | 1.5 − 0.5j | 0.5 − 1.5j | 0.5858 | 0.5 + 1.5j | 1.5 + 0.5j | 0.5 + 0.5j |

Compensation is performed for h/2 of the factor like the channel,
and the even location is set to zero, to obtain the 2^{nd} first signal, where M = 8

| | | | | | | | |
|---|---|---|---|---|---|---|---|
| 0 | 1 − j | 0 | 1 − 3j | 0 | 1 + 3j | 0 | 1 + j |

It should be noted that, when the compensation is performed for h/2 of the factor like the channel in Table 14, the signal obtained after the IFFT, IFT, FFT, or FT operation is performed on the group of signal points corresponding to the 2^{nd} first signal is multiplied by 2, to compensate for the factor like the channel. It should be understood that h/2 may be another value through the compensation. This is merely an example herein, and is not particularly limited.

(8) The receiver performs the IFFT, IFT, FFT, or FT operation on the 1^{st} first signal and the 2^{nd} first signal that are shown in Table 13 and Table 14, to obtain the 1^{st} third signal and the 2^{nd} third signal, as shown in Table 15 and Table 16.

TABLE 15
1^{st} third signal, where M = 8

| | | | | | | | |
|---|---|---|---|---|---|---|---|
| −1 | −0.707 | 1 | 0 | 1 | 0.707 | −1 | 0 |

TABLE 16
2^{nd} third signal, where M = 8

| | | | | | | | |
|---|---|---|---|---|---|---|---|
| 0.5 | 0.707 | −0.5 | 0.707 | −0.5 | −0.707 | 0.5 | −0.707 |

(9) The receiver obtains A1 and/or B1 and A2 and/or B2 based on the antisymmetric characteristic of the third signal, as shown in Table 17 and Table 18.

TABLE 17

| | | | | |
|---|---|---|---|---|
| A1 | 0 | 0 | 1 | 0 |
| B1 | 1 | 0.707 | 0 | 0 |

TABLE 18

| | | | | |
|---|---|---|---|---|
| A2 | 0.5 | 0.707 | 0 | 0.707 |
| B2 | 0 | 0 | 0.5 | 0 |

(10) The receiver obtains C1 based on C1=(A1+C1)−A1, C1=(B1+C1)−B1, C1=((A1+C1)+(B1+C1)+C1)−B1, and/or the like, as shown in Table 19. The receiver obtains D1 based on D1=(A2+D1)−A2, D1=(B2+D1)−B2, D1=((A2+D1)+(B2+D1)−A2−B2)/2, and/or the like, as shown in Table 20.

TABLE 19

| | | | | |
|---|---|---|---|---|
| C1 | 0 | 0 | 0.75 | 0.25 |

TABLE 20

| | | | | |
|---|---|---|---|---|
| D1 | 0.75 | 0.25 | 0 | 0 |

(11) The receiver obtains C1-D1 based on C1 and D1, and obtains values of eight signal points of the fourth signal based on the symmetric characteristic of the fourth signal, as shown in Table 21.

TABLE 21

| (C1 − D1) | | | | (C1 − D1) | | | |
|---|---|---|---|---|---|---|---|
| −0.75 | −0.25 | 0.75 | 0.25 | −0.75 | −0.25 | 0.75 | 0.25 |

(12) The receiver performs the IFFT, IFT, FFT, or FT operation on the eight signal points in Table 21, to obtain the second signal, as shown in Table 22.

TABLE 22
Second signal, where M = 8

| | | | | | | | |
|---|---|---|---|---|---|---|---|
| 0 | 0 | −3 + j | 0 | 0 | 0 | −3 − j | 0 |

It should be noted that any table in Table 1 to Table 22 may be combined or split. This is not limited in this embodiment of this application.

Through the foregoing operations, the fifth signal transmitted by the transmitter over the air interface is a non-negative signal, and the receiver can restore, through IFFT, IFT, FFT, or FT, the signal obtained from the transmitter.

To enable a reader to understand the solution provided in embodiments of this application, the following provides an example in which N=2 to describe the method provided in embodiments of this application. It should be understood that this example constitutes no limitation on the method provided in embodiments of this application, and is merely a simple example for ease of understanding by the reader.

When N=2, this example is briefly described according to the foregoing method.

The transmitter obtains four first signals and three second signals.

A 1^{st} third signal is determined by performing IFFT, IFT, FFT, or FT on a 1^{st} first signal, and a 1^{st} sixth signal and a 1^{st} seventh signal, namely, A1 and B1, are obtained based on the 1^{st} third signal.

A 2^{nd} third signal is determined by performing IFFT, IFT, FFT, or FT on a 2^{nd} first signal, and a 2^{nd} sixth signal and a 2^{nd} seventh signal, namely, A2 and B2, are obtained based on the 2^{nd} third signal.

A3^{rd} third signal is determined by performing IFFT, IFT, FFT, or FT on a 3^{rd} first signal, and a 3^{rd} sixth signal and a 3^{rd} seventh signal, namely, A3 and B3, are obtained based on the 3^{rd} third signal.

A 4^{th} third signal is determined by performing IFFT, IFT, FFT, or FT on a 4^{th} first signal, and a 4^{th} sixth signal and a 4^{th} seventh signal, namely, A4 and B4, are obtained based on the 4^{th} third signal.

A 1^{st} fourth signal is determined by performing IFFT, IFT, FFT, or FT on a 1^{st} second signal, and a 1^{st} eighth signal and a 1^{st} ninth signal, namely, C1 and D1, are obtained based on the 1^{st} fourth signal.

A2^{nd} fourth signal is determined by performing IFFT, IFT, FFT, or FT on a 2^{nd} second signal, and a 2^{nd} eighth signal and a 2^{nd} ninth signal, namely, C2 and D2, are obtained based on the 2^{nd} fourth signal.

A 3^{rd} fourth signal is determined by performing IFFT, IFT, FFT, or FT on a 3^{rd} second signal, and a 3^{rd} eighth signal and a 3^{rd} ninth signal, namely, C3 and D3, are obtained based on the 3^{rd} fourth signal.

It should be noted that, all the 2^{N}−1 second signals used as an example herein are the signals whose signal point at the odd location is 0, all the 2^{N}−1 second signals are the signals whose signal point at the even location is 0, or some of the second signals in the 2^{N}−1 second signals are the signals whose signal point at the even location is 0, or some of the second signals are the signals whose signal point at the odd location is 0.

The transmitter mixes the signals to obtain the fifth signal sent over the air interface, which may be:

(A1+C1+C2), (B1+C1+C2), (A2+D1+C2), (B2+D1+C2), (A3+C3+D2), (B3+C3+D2), (A4+D3+D2), and (B4+D3+D2).

It should be understood that a sequence of transmitting (A1+C1+C2), (B1+C1+C2), (A2+D1+C2), (B2+D1+C2), (A3+C3+D2), (B3+C3+D2) (A4+D3+D2), and (B4+D3+D2) over the air interface is not limited.

(A1+C1+C2) and (B1+C1+C2) correspond to one group of signal points of the fifth signal. As described above, the group of signal points corresponds to the 1^{st} first signal. M/2 signal points of the group of signal points are determined based on the 1^{st} sixth signal, namely, A1, and a 1^{st} signal combination, namely, C1+C2. The other M/2 signal points are determined based on the 1^{st} seventh signal, namely, B1, and the first signal combination, namely, C1+C2. Any two groups of signal points correspond to different signal combinations, and all signal combinations include all eighth signals and ninth signals. The eighth signal and the ninth signal corresponding to a same signal combination come from different fourth signals, that is, there is no signal combination Cn+Dn, for example, C1+D1.

The transmitter transmits the fifth signal, and correspondingly, the receiver receives the fifth signal.

Specifically, after receiving the fifth signal, as described above, the receiver divides, in the mixing manner learned in advance, the fifth signal, and separates and restores, by using the same method as described above, the fifth signal.

Details are as follows:
The 1^{st} first signal, namely, C1+C2, is restored by performing IFFT, IFT, FFT, or FT on (A1+C1+C2) and (B1+C1+C2);
the 2^{nd} first signal, namely, D1+C2, is restored by performing IFFT, IFT, FFT, or FT on (A2+D1+C2) and (B1+D1+C2);
the 1^{st} second signal, namely C2, is restored by performing IFFT, IFT, FFT, or FT on (C1+C2)−(D1+C2)=C1-D1;
the 3^{rd} first signal, namely, C3+D2, is restored by performing IFFT, IFT, FFT, or FT on (A3+C3+D2) and (B3+C3+D2);
the 4^{th} first signal, namely, D3+D2, is restored by performing IFFT, IFT, FFT, or FT on (A4+D3+D2) and (B4+D3+D2);
the 3^{rd} second signal, namely D2, is restored by performing IFFT, IFT, FFT, or FT on (C3+D2)−(D3+D2)=C3−D3; and C2−D2 is obtained, and the 2^{nd} second signal is restored by performing IFFT, IFT, FFT, or FT on C2−D2.

According to the method provided in embodiments of this application, the receiver may restore, based on the input signal including the M*2^{N} signal points, the input signal that is of the transmitter and that includes the M*(2^{N+1}−1) signal points. Because the input signals obtained by the transmitter are all set to 0 at the even or odd locations, spectral efficiency is lost by ½. Therefore, in embodiments of this application, when the HS constraint (the loss of ½ efficiency) is met, spectral efficiency of signal transmission is ½*½*(M*(2^{N+1}−1))/(M*2^{N})(2^{N+1}−1)/2^{N+2}. In addition, no direct current bias is added to increase power consumption. When N=1, the spectral efficiency of the method provided in embodiments of this application is ⅜. When N=2, the spectral efficiency of the method provided in embodiments of this application is 7/16. Compared with the previously mentioned solution in which the baseband signal of the OFDM signal is the non-negative real number at the expense of the spectral efficiency and/or the power consumption, according to the signal transmission method provided in embodiments of this application, the spectral efficiency is improved without increasing the power consumption while ensuring that the baseband signal of the OFDM signal is the non-negative real number.

Sequence numbers of the foregoing processes do not mean execution sequences in the foregoing method embodiments. The execution sequences of the processes should be determined based on functions and internal logic of the processes, and should not constitute any limitation on implementation processes of embodiments of this application. In addition, it is possible that not all operations in the foregoing method embodiments need to be performed.

It should be understood that the transmitter or the receiver in the foregoing method embodiments may perform a part or all of the operations in embodiments. These operations or operations are merely examples. Embodiments of this application may further include performing other operations or variations of various operations.

It should be further understood that in various embodiments of this application, unless otherwise specified or logically conflicted, terms and/or descriptions in different embodiments may be consistent and may be mutually referenced, and technical features in different embodiments may be combined based on an internal logical relationship thereof, to form a new embodiment.

FIG. 13 shows an example of a signal transmission apparatus according to an embodiment of this application. As shown in FIG. 13, an apparatus 1300 includes a transceiver unit 1310 and a processing unit 1320.

In some embodiments, the signal transmission apparatus 1300 may be configured to implement a function of the transmitter in any one of the foregoing method embodiments. For example, the signal transmission apparatus 1300 may correspond to the transmitter.

The signal transmission apparatus 1300 may be used as the transmitter, and perform operations performed by the transmitter in the foregoing method embodiments. The transceiver unit 1310 may be configured to support the signal transmission apparatus 1300 in performing communication, for example, performing a sending and/or receiving action performed by the transmitter in FIG. 7. The processing unit 1320 may be configured to support the signal transmission apparatus 1300 in performing a processing action in the foregoing method embodiments, for example, performing a processing action performed by the transmitter in FIG. 7.

In some embodiments, the signal transmission apparatus 1300 may be configured to implement a function of the receiver in any one of the foregoing method embodiments. For example, the signal transmission apparatus 1300 may correspond to the receiver.

The signal transmission apparatus 1300 may be used as the receiver, and perform operations performed by the receiver in the foregoing method embodiments. The transceiver unit 1310 may be configured to support the signal transmission apparatus 1300 in performing communication, for example, performing a sending and/or receiving action performed by the receiver in FIG. 7. The processing unit 1320 may be configured to support the signal transmission apparatus 1300 in performing a processing action in the foregoing method embodiments, for example, performing a processing action performed by the receiver in FIG. 7.

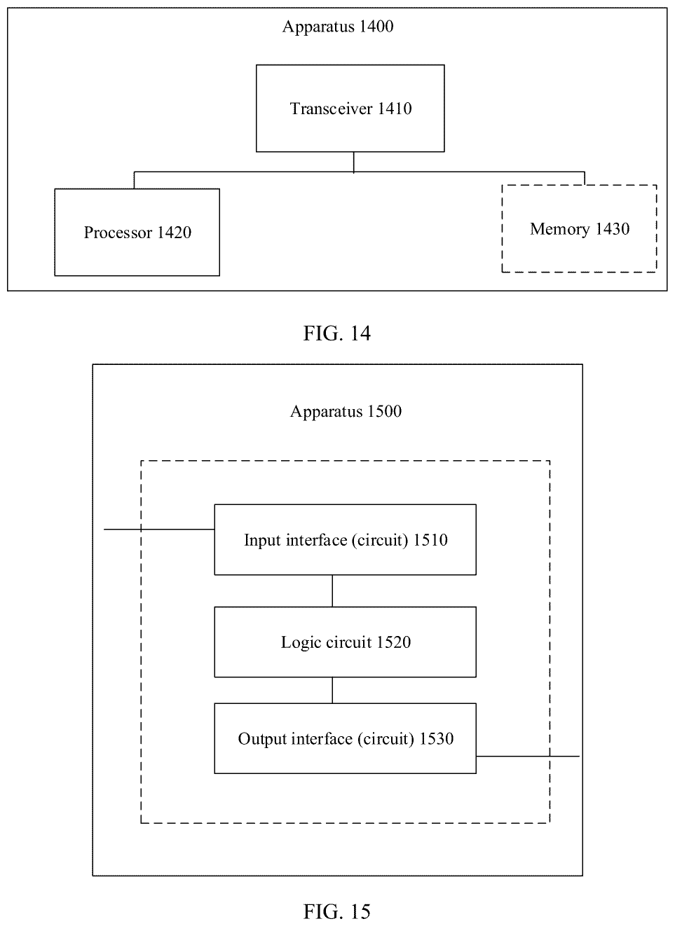

FIG. 14 shows an example of a signal transmission apparatus 1400 according to an embodiment of this application. As shown in FIG. 14, the apparatus 1400 includes a transceiver 1410, a processor 1420, and a memory 1430. The memory 1430 is configured to store instructions. The processor 1420 is coupled to the memory 1430, and is configured to execute the instructions stored in the memory, to perform the method provided in embodiments of this application.

Specifically, the transceiver 1410 in the apparatus 1400 may correspond to the transceiver unit 1310 in the apparatus 1300, and the processor 1420 in the communication apparatus 1400 may correspond to the processing unit 1320 in the communication apparatus 1300.

It should be understood that the memory 1430 and the processor 1420 may be integrated into one processing apparatus, and the processor 1420 is configured to execute program code stored in the memory 1430 to implement the foregoing functions. During implementation, the memory 1430 may alternatively be integrated into the processor 1420, or may be independent of the processor 1420.

It should be understood that a process in which the transceiver and the processor perform the foregoing corresponding operations is described in detail in the foregoing method embodiments. For brevity, details are not described herein again.

FIG. 15 shows another example of a signal transmission apparatus according to an embodiment of this application. The apparatus may be configured to perform the method performed by the transmitter or the receiver. As shown in FIG. 15, the apparatus includes:
at least one input interface (Input(s)) 1510, a logic circuit 1520, and at least one output interface (Output(s)) 1530. In an embodiment, the logic circuit may be a chip or another integrated circuit that can implement the method in this application.

The input interface 1510 is configured to input or receive data. The output interface 1530 is configured to output or send data. The logic circuit 1520 is configured to perform the various possible methods described in FIG. 7.

This application further provides a chip, including a processor. The processor is configured to read and run a computer program stored in a memory, to perform a corresponding operation and/or procedure performed by the transmitter in the signal transmission method provided in this application. In an embodiment, the chip further includes a memory, the memory and the processor are connected to the memory over a circuit or a wire, and the processor is configured to read and execute a computer program in the memory. Further, in an embodiment, the chip further includes a communication interface, and the processor is connected to the communication interface. The communication interface is configured to receive data and/or information that needs to be processed, and the processor obtains the data and/or information from the communication interface, and processes the data and/or information. The communication interface may be an input/output interface.

This application further provides a chip, including a processor. The processor is configured to read and run a computer program stored in a memory, to perform a corresponding operation and/or procedure performed by the receiver in the signal transmission method provided in this application. In an embodiment, the chip further includes a memory, the memory and the processor are connected to the memory over a circuit or a wire, and the processor is configured to read and execute a computer program in the memory. Further, in an embodiment, the chip further includes a communication interface, and the processor is connected to the communication interface. The communication interface is configured to receive data and/or information that needs to be processed, and the processor obtains the data and/or information from the communication interface, and processes the data and/or information. The communication interface may be an input/output interface.

It should be noted that the processor in this application may be a central processing unit (CPU), an application-specific integrated circuit (ASIC), or one or more integrated circuits configured to implement embodiments of this application, for example, one or more digital signal processors (DSP) or one or more field programmable gate arrays (FPGA).

A representation form of the processor is not limited in this application, provided that the processor can be configured to complete an internal processing function of a corresponding device. One of ordinary skilled in the art may be aware that units and algorithm operations described with reference to embodiments disclosed in this specification can be implemented by electronic hardware, or a combination of computer software and electronic hardware. Whether the functions are performed by hardware or software depends on particular applications and design constraints of the technical solutions. One of ordinary skilled in the art may use different methods to implement the described functions for each particular application, but it should not be considered that the implementation goes beyond the scope of this application.

It should be understood that the chip may alternatively be replaced with a chip system, and details are not described herein. Terms “include”, “have”, and any other variants thereof in this application are intended to cover non-exclusive inclusion. For example, a process, method, system, product, or device that includes a series of operations or units are not limited to those operations or units that are clearly listed, but may include other operations or units that are not explicitly listed or are inherent to such a process, method, product, or device.

One of ordinary skilled in the art may be aware that units and algorithm operations described with reference to embodiments disclosed in this specification can be implemented by electronic hardware, or a combination of computer software and electronic hardware. Whether the functions are performed by hardware or software depends on particular applications and design constraints of the technical solutions. One of ordinary skilled in the art may use different methods to implement the described functions for each particular application, but it should not be considered that the implementation goes beyond the scope of this application.

One of ordinary skilled in the art may clearly understand that, for convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate components may or may not be physically separate, and components displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the operations of the methods described in embodiments of this application. The storage medium includes any medium that can store program code, such as a USB flash drive, a removable hard disk, a read-only memory (ROM), a random access memory (RAM), a magnetic disk, or an optical disc.

The foregoing descriptions are merely implementations of this application, but are not intended to limit the protection scope of this application. Any variation or replacement readily figured out by one of ordinary skilled in the art within the technical scope disclosed in this application shall fall within the protection scope of this application. Therefore, the protection scope of this application shall be subject to the protection scope of the claims.

1. A signal transmission method, comprising:
obtaining 2^{N} first signals and 2^{N}−1 second signals, wherein each of the first signals comprises M signal points, a signal value, at an even location, of the M signal points of the first signal is 0, each of the second signals comprises M signal points, a signal value, at an odd location or an even location, of the M signal points of the second signal is 0, N is a positive integer, and M is a positive even number;
performing inverse fast Fourier transform (IFFT), inverse Fourier transform (IFT), fast Fourier transform (FFT), or Fourier transform (FT) on the 2^{N} first signals and the 2^{N}−1 second signals to determine 2^{N} third signals and 2^{N}−1 fourth signals, wherein each of the third signals comprises M signal points, and each of the fourth signals comprises M signal points;
determining a fifth signal based on the 2^{N} third signals and the 2^{N}−1 fourth signals, wherein the fifth signal comprises M*2^{N} signal points; and
sending the fifth signal.

2. The method according to claim 1, wherein the determining the fifth signal based on the 2^{N} third signals and the 2^{N}−1 fourth signals comprises:
Determining 2^{N} sixth signals and 2^{N} seventh signals based on the 2^{N} third signals, wherein each of the sixth signals comprises M/2 signal points, each of the seventh signals comprises M/2 signal points, an i^{th} sixth signal in the 2^{N} sixth signals and an i^{th} seventh signal in the 2^{N} seventh signals are determined based on an i^{th} third signal in the 2^{N} third signals, and i is a positive integer less than or equal to 2^{N};
determining 2^{N}−1 eighth signals and 2^{N}−1 ninth signals based on the 2^{N}−1 fourth signals, wherein each of the eighth signals comprises M/2 signal points, each of the ninth signals comprises M/2 signal points, an x^{th} eighth signal in the 2^{N}−1 eighth signals and an x^{th} ninth signal in the 2^{N}−1 ninth signals are determined based on an x^{th} fourth signal in the 2^{N}−1 fourth signals, and x is a positive integer less than or equal to 2^{N}−1; and
determining the fifth signal based on the 2^{N} sixth signals, the 2^{N} seventh signals, the 2^{N}−1 eighth signals, and the 2^{N}−1 ninth signals.

3. The method according to claim 2, wherein that the i^{th} sixth signal in the 2^{N} sixth signals and the i^{th} seventh signal in the 2^{N} seventh signals are determined based on the i^{th} third signal in the 2^{N} third signals comprises:
the i^{th} sixth signal is obtained by setting a signal value less than 0 and that corresponds to first M/2 signal points of the i^{th} third signal, or the i^{th} sixth signal is obtained by setting a signal value greater than 0 and that corresponds to last M/2 signal points of the i^{th} third signal to 0 and calculating an absolute value of a signal value less than 0 and that corresponds to the last M/2 signal points of the i^{th} third signal; and
the i^{th} seventh signal is obtained by setting the signal value less than 0 and that corresponds to the last M/2 signal points of the i^{th} third signal, or the i^{th} seventh signal is obtained by setting a signal value greater than 0 and that corresponds to the first M/2 signal points of the i^{th} third signal to 0 and calculating an absolute value of the signal value less than 0 and that corresponds to the first M/2 signal points of the i^{th} third signal.

4. The method according to claim 2, wherein that the x^{th} eighth signal in the 2^{N}−1 eighth signals and the x^{th} ninth signal in the 2^{N}−1 ninth signals are determined based on the x^{th} fourth signal in the 2^{N}−1 fourth signals comprises:
the x^{th} eighth signal is obtained by setting a signal value less than 0 and that corresponds to first M/2 signal points or the last M/2 signal points of the x^{th} fourth signal to 0; and
the x^{th} ninth signal is obtained by setting a signal value greater than 0 and that corresponds to the first M/2 signal points or the last M/2 signal points of the x^{th} fourth signal to 0 and calculating an absolute value of the signal value less than 0 and that corresponds to the first M/2 signal points or the last M/2 signal points of the x^{th} fourth signal; or
the x^{th} eighth signal is obtained by setting a signal value less than 0 and that corresponds to the first M/2 signal points of the x^{th} fourth signal, or the x^{th} eighth signal is obtained by setting a signal value greater than 0 and that corresponds to the last M/2 signal points of the x^{th} fourth signal to 0 and calculating an absolute value of a signal value less than 0 and that corresponds to the last M/2 signal points of the x^{th} fourth signal; and
the x^{th} ninth signal is obtained by setting the signal value less than 0 and that corresponds to the last M/2 signal points of the x^{th} fourth signal, or the x^{th} ninth signal is obtained by setting a signal value greater than 0 and that corresponds to the first M/2 signal points of the x^{th} fourth signal to 0 and calculating an absolute value of the signal value less than 0 and that corresponds to the first M/2 signal points of the x^{th} fourth signal.

5. The method according to claim 1, wherein the M*2^{N} signal points of the fifth signal comprise 2^{N} groups of signal points, each group of signal points comprises M signal points, the 2^{N} groups of signal points one-to-one correspond to the 2^{N} first signals and 2^{N} signal combinations, M/2 signal points in one group of signal points of the fifth signal and that corresponds to an i^{th} first signal are determined based on the i^{th} sixth signal and an i^{th} signal combination, the other M/2 signal points are determined based on the i^{th} seventh signal and the i^{th} signal combination, the signal combination comprises at least N eighth signals and/or ninth signals, the at least N eighth signals and/or ninth signals are determined based on at least N different fourth signals, and any two signal combinations in the 2^{N} signal combinations comprise at least one different eighth signal or ninth signal.

6. The method according to claim 5, wherein that M/2 signal points in one group of signal points of the fifth signal and that corresponds to the i^{th} first signal are determined based on the i^{th} sixth signal and an i^{th} signal combination comprises:
a signal value of the M/2 signal points in the group of signal points of the fifth signal and that corresponds to the i^{th} first signal is a sum of a signal value of M/2 signal points of the i^{th} sixth signal and a signal value, at a corresponding location, of N*M/2 signal points of the at least N eighth signals and/or ninth signals comprised in the i^{th} signal combination; and
that the other M/2 signal points are determined based on the i^{th} seventh signal and the i^{th} signal combination comprises:
a signal value of the other M/2 signal points in the group of signal points of the fifth signal and that corresponds to the i^{th} first signal is a sum of a signal value of M/2 signal points of the i^{th} seventh signal and the signal value, at the corresponding location, of the N*M/2 signal points of the at least N eighth signals and/or ninth signals comprised in the i^{th} signal combination.

7. A signal transmission method, comprising:
obtaining a fifth signal comprising M*2^{N} signal points, wherein N is a positive integer, and M is a positive even number; and
performing at least one of following operations on the fifth signal to determine 2^{N} first signals and 2^{N}−1 second signals, wherein each of the first signals comprises M signal points, a signal value, at an even location, of the M signal points of the first signal is 0, each of the second signals comprises M signal points, a signal value, at an odd location or an even location, of the M signal points of the second signal is 0, and the operations comprises:
inverse fast Fourier transform (IFFT), inverse Fourier transform (IFT), fast Fourier transform (FFT), or Fourier transform (FT).

8. The method according to claim 7, wherein the M*2^{N} signal points of the fifth signal comprise 2^{N} groups of signal points, each group of signal points comprises M signal points, and the 2^{N} groups of signal points one-to-one correspond to the 2^{N} first signals and 2^{N} signal combinations.

9. The method according to claim 7, wherein the performing at least one of the following operations on the fifth signal to obtain 2^{N} first signals and 2^{N}−1 second signals comprises:
separately performing IFFT, IFT, FFT, or FT on the 2^{N} groups of signal points of the fifth signal to obtain the 2^{N} first signals;
separately performing IFFT, IFT, FFT, or FT on the 2^{N} first signals to determine 2^{N} third signals, wherein the third signal comprises M signal points;
determining the 2^{N} signal combinations based on the 2^{N} third signals; and
determining the 2^{N}−1 second signals based on the 2^{N} signal combinations, wherein the operations comprises IFFT, IFT, FFT, or FT.

10. The method according to claim 7, wherein the determining the 2^{N} signal combinations based on the 2^{N} third signals comprises:
determining 2^{N} sixth signals and/or 2^{N} seventh signals based on the 2^{N} third signals, wherein each of the sixth signals comprises M/2 signal points, each of the seventh signals comprises M/2 signal points, an i^{th} sixth signal in the 2^{N} sixth signals and an i^{th} seventh signal in the 2^{N} seventh signals are determined based on an i^{th} third signal in the 2^{N} third signals, and i is a positive integer less than or equal to 2^{N}; and
determining the 2^{N} signal combinations based on the 2^{N} sixth signals and/or 2^{N} seventh signals.

11. The method according to claim 7, wherein the obtaining the 2^{N}−1 second signals based on the 2^{N} signal combinations comprises:
determining 2^{N}−1 fourth signals based on the 2^{N} signal combinations, wherein the fourth signal comprises M signal points; and
separately performing IFFT, IFT, FFT, or FT on the 2^{N}−1 fourth signals to obtain the 2^{N}−1 second signals.

12. The method according to claim 7, wherein the determining the 2^{N} signal combinations based on the 2^{N} sixth signals and/or 2^{N} seventh signals comprises:
determining the 2^{N} signal combinations based on M/2 signal points of each group of signal points in the 2^{N} groups of signal points of the fifth signal and a sixth signal determined based on a first signal corresponding to the group of signal points, or determining the 2^{N} signal combinations based on the other M/2 signal points of each group of signal points in the 2^{N} groups of signal points of the fifth signal and a seventh signal determined based on a first signal corresponding to the group of signal points, wherein
an i^{th} signal combination is determined based on M/2 signal points of one group of signal points corresponding to an i^{th} first signal and the i^{th} sixth signal determined based on the i^{th} first signal, or an i^{th} signal combination is determined based on the other M/2 signal points of one group of signal points corresponding to the i^{th} first signal and the i^{th} seventh signal determined based on the i^{t} first signal.

13. A signal transmission apparatus, comprising:
a processor; and
a memory couple to the processor to store instructions, which when executed by the processor, cause the apparatus to perform operations, the operations comprising:
obtaining a fifth signal comprising M*2^{N} signal points,
wherein N is a positive integer, and M is a positive even number; and
performing at least one of following operations on the fifth signal to determine 2^{N} first signals and 2^{N}−1 second signals, wherein each of the first signals comprises M signal points, a signal value, at an even location, of the M signal points of the first signal is 0, each of the second signals comprises M signal points, a signal value, at an odd location or an even location, of the M signal points of the second signal is 0, and the operations comprises:
inverse fast Fourier transform (IFFT), inverse Fourier transform (IFT), fast Fourier transform (FFT), or Fourier transform (FT).

14. The apparatus according to claim 13, wherein the M*2^{N} signal points of the fifth signal comprise 2^{N} groups of signal points, each group of signal points comprises M signal points, and the 2^{N} groups of signal points one-to-one correspond to the 2^{N} first signals and 2^{N} signal combinations.

15. The apparatus according to claim 13, wherein the M*2^{N} signal points of the fifth signal comprise 2^{N} groups of signal points, each group of signal points comprises M signal points, and the 2^{N} groups of signal points one-to-one correspond to the 2^{N} first signals and 2^{N} signal combinations.

16. The apparatus according to claim 13, wherein the performing at least one of the following operations on the fifth signal to obtain 2^{N} first signals and 2^{N}−1 second signals comprises:
separately performing IFFT, IFT, FFT, or FT on the 2^{N} groups of signal points of the fifth signal to obtain the 2^{N} first signals;
separately performing IFFT, IFT, FFT, or FT on the 2^{N} first signals to determine 2^{N} third signals, wherein the third signal comprises M signal points;
determining the 2^{N} signal combinations based on the 2^{N} third signals; and
determining the 2^{N}−1 second signals based on the 2^{N} signal combinations, wherein the operations comprises IFFT, IFT, FFT, or FT.

17. The apparatus according to claim 13, wherein the determining the 2^{N} signal combinations based on the 2^{N} third signals comprises:
determining 2^{N} sixth signals and/or 2^{N} seventh signals based on the 2^{N} third signals, wherein each of the sixth signals comprises M/2 signal points, each of the seventh signals comprises M/2 signal points, an i^{th} sixth signal in the 2^{N} sixth signals and an i^{th} seventh signal in the 2^{N} seventh signals are determined based on an i^{th} third signal in the 2^{N} third signals, and i is a positive integer less than or equal to 2^{N}; and
determining the 2^{N} signal combinations based on the 2^{N} sixth signals and/or 2^{N} seventh signals.

18. The apparatus according to claim 13, wherein the obtaining the 2^{N}−1 second signals based on the 2^{N} signal combinations comprises:
determining 2^{N}−1 fourth signals based on the 2^{N} signal combinations, wherein the fourth signal comprises M signal points; and
separately performing IFFT, IFT, FFT, or FT on the 2^{N}−1 fourth signals to obtain the 2^{N}−1 second signals.

19. The apparatus according to claim 13, wherein the determining the 2^{N} signal combinations based on the 2^{N} sixth signals and/or 2^{N} seventh signals comprises:
determining the 2^{N} signal combinations based on M/2 signal points of each group of signal points in the 2^{N} groups of signal points of the fifth signal and a sixth signal determined based on a first signal corresponding to the group of signal points, or determining the 2^{N} signal combinations based on the other M/2 signal points of each group of signal points in the 2^{N} groups of signal points of the fifth signal and a seventh signal determined based on a first signal corresponding to the group of signal points, wherein
an i^{th} signal combination is determined based on M/2 signal points of one group of signal points corresponding to an i^{th} first signal and the i^{th} sixth signal determined based on the i^{th} first signal, or an i^{th} signal combination is determined based on the other M/2 signal points of one group of signal points corresponding to the i^{th} first signal and the i^{th} seventh signal determined based on the i^{th} first signal.
